(19) United States
(12) Patent Application Publication
(10) Pub. No.: US 2025/0142557 A1
(43) Pub. Date: May 1, 2025

(54) TERMINAL DEVICE, PROCESSING DEVICE, AND NON-TRANSITORY COMPUTER-READABLE STORAGE MEDIUM

(71) Applicant: KABUSHIKI KAISHA TOSHIBA, Tokyo (JP)

(72) Inventors: Haruka OBATA, Ota Tokyo (JP); Yuki YONEZAWA, Ayase Kanagawa (JP); Kentaro TANIGUCHI, Kawasaki Kanagawa (JP)

(73) Assignee: KABUSHIKI KAISHA TOSHIBA, Tokyo (JP)

(21) Appl. No.: 18/768,059

(22) Filed: Jul. 10, 2024

(30) Foreign Application Priority Data
Nov. 1, 2023 (JP) 2023-187529

(51) Int. Cl. H04W 72/12; H04W 24/02; H04W 72/0446; H04W 72/51

(52) U.S. Cl. CPC H04W 72/12; H04W 24/02; H04W 72/0446; H04W 72/51

(57) ABSTRACT

According to one embodiment, a terminal device wirelessly communicates with a base station. The terminal device includes a controller and a communication device. The controller predicts a first time at which first data to be transmitted to the base station will occur. The communication device transmits a scheduling request to the base station at a second time before the first data actually occurs, based on the first time. The scheduling request requests allocation of a communication resource.

### CROSS-REFERENCE TO RELATED APPLICATIONS

This application is based upon and claims the benefit of priority from Japanese Patent Application No. 2023-187529, filed Nov. 1, 2023, the entire contents of which are incorporated herein by reference.

### FIELD

Embodiments described herein relate generally to a terminal device, a processing device, and a non-transitory computer-readable storage medium.

### BACKGROUND

In the Third Generation Partnership Project (3GPP (registered trademark)), mobile communication systems have been standardized, and standardization of a new mobile communication system is being considered. The mobile communication systems that have been standardized are, for example, the fourth-generation mobile communication system (4G mobile communication system or LTE-Advanced mobile communication system) and the fifth-generation mobile communication system (5G mobile communication system). The mobile communication system under consideration for standardization is, for example, the sixth-generation mobile communication system (6G mobile communication system).

A mobile communication system includes a base station and a terminal device. For example, when data to be transmitted to the base station (uplink data) has occurred (i.e., when uplink data has been generated), the terminal device requests the base station to allocate a resource for transmitting the uplink data. The base station allocates a resource for wireless communication (communication resource) in response to this request. The terminal device transmits the uplink data to the base station by using the allocated communication resource.

In a case where the allocation of a communication resource is requested to the base station after uplink data occurs and the uplink data is transmitted by using the communication resource allocated in response to the request, latency (waiting time) occurs before the uplink data is actually transmitted.

### BRIEF DESCRIPTION OF THE DRAWINGS

FIG. 1 is a block diagram showing an example of a configuration of a communication system that includes a terminal device according to a first embodiment.

FIG. 2 is a view illustrating an example of a frame configuration of a radio signal that is transferred between a base station and the terminal device according to the first embodiment.

FIG. 3 is a view illustrating an example of communication resources used in the communication system that includes the terminal device according to the first embodiment.

FIG. 4 is a view illustrating a flow from an occurrence to transmitting of uplink data in a terminal device according to a comparative example.

FIG. 5 is a view illustrating an occurrence and transmitting of uplink data at a fixed cycle in the terminal device according to the comparative example.

FIG. 6 is a view illustrating an example of regular uplink data occurrence in the terminal device according to the first embodiment.

FIG. 7 is a view illustrating another example of regular uplink data occurrence in the terminal device according to the first embodiment.

FIG. 8 is a block diagram illustrating an example of a configuration of the terminal device according to the first embodiment.

FIG. 9 illustrates an example of a configuration of a data management table used in the terminal device according to the first embodiment.

FIG. 10 is a view illustrating an example of a timing at which the terminal device according to the first embodiment transmits a scheduling request.

FIG. 11 is a view illustrating (a) latency from an occurrence to transmitting of uplink data in the terminal device according to the comparative example and (b) an example of latency from an occurrence to transmitting of uplink data in the terminal device according to the first embodiment.

FIG. 12 is a sequence diagram illustrating an example of an operation for transmitting uplink data from the terminal device according to the first embodiment to the base station.

FIG. 13 is a flowchart illustrating an example of the procedure of a scheduling request transmitting control process executed in the terminal device according to the first embodiment.

FIG. 14 is a flowchart illustrating an example of the procedure of an uplink data transmitting control process executed in the terminal device according to the first embodiment.

FIG. 15 is a block diagram illustrating an example of a configuration of a base station according to a second embodiment.

FIG. 16 is a view illustrating an example of a protocol stack of the base station according to the second embodiment.

FIG. 17 is a view illustrating an example of the protocol stack and interfaces of the base station according to the second embodiment.

FIG. 18 is a view illustrating an example of processing units that correspond to an RF layer, a low PHY layer, and a high PHY layer related to uplink communication in the base station according to the second embodiment.

FIG. 19 is a sequence diagram illustrating an example of an operation for transmitting uplink data from a terminal device to the base station according to the second embodiment.

FIG. 20 is a flowchart illustrating an example of the procedure of an allocation control process executed in the base station according to the second embodiment.

### DETAILED DESCRIPTION

In general, according to an embodiment, a terminal device wirelessly communicates with a base station. The terminal device includes a controller and a communication device. The controller predicts a first time at which first data to be transmitted to the base station will occur. The communication device transmits a scheduling request to the base station at a second time before the first data actually occurs, based on the first time. The scheduling request requests allocation of a communication resource.

Various embodiments will be described hereinafter with reference to the accompanying drawings.

### First Embodiment

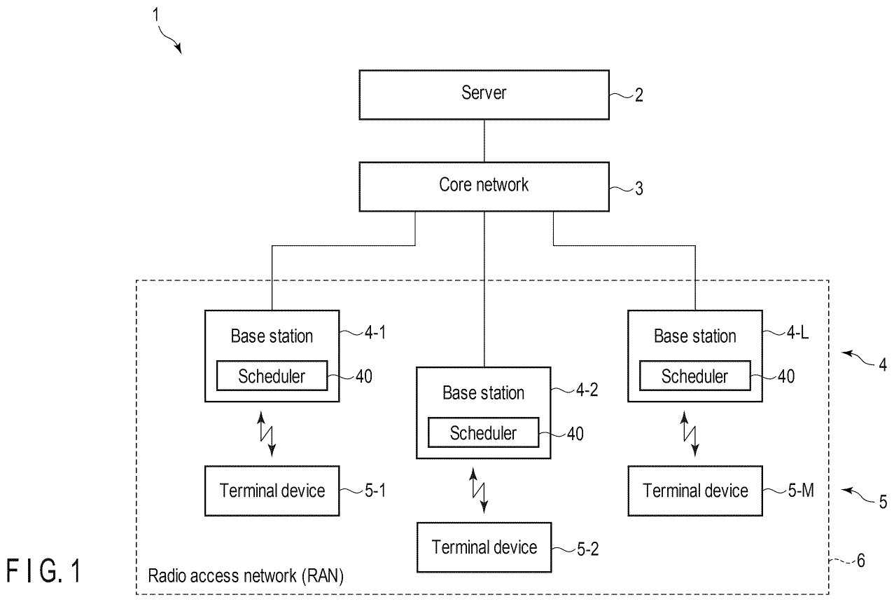

FIG. 1 is a block diagram illustrating an example of a configuration of a communication system that includes a terminal device according to a first embodiment. The communication system 1 is, for example, a wireless communication system conforms to a mobile communication system standardized in the 3GPP or a mobile communication system for which standardization is being considered. The mobile communication system is, for example, the fourth-generation mobile communication system (4G system or LTE-Advanced system) or the fifth-generation mobile communication system (5G system) standardized in the 3GPP, or the sixth-generation mobile communication system (6G system) being considered for standardization in the 3GPP.

The communication system 1 includes, for example, a server 2, a core network 3, base stations 4, and terminal devices 5.

The server 2 is a server computer. The server 2 provides, for example, a specific service to each of the terminal devices 5 via the core network 3 and the base stations 4.

The core network 3 is a backbone communication network in the mobile communication system. The core network 3 includes, for example, a switching device and a subscriber information management device. The core network 3 may be connected to the server 2 and each of the base stations 4. The core network 3 relays transfer of data (e.g., a packet) between the server 2 and any of the base stations 4 that are connected to the core network 3. The core network 3 also relays transfer of data between one of the base stations 4 and another one of the base stations 4 that are connected to the core network 3.

Each of the base stations 4 is a wireless communication device conforming to the mobile communication system (e.g., 5G system). The base stations 4, together with antennas, transmitting lines, etc., configure a radio access network (RAN) 6. Together with the core network 3, the RAN 6 configures a network specified by the mobile communication system. The base stations 4 are, for example, L base stations 4-1, 4-2, . . . , and 4-L, where L is an integer of one or more. In the following, any one of the base stations 4 is also referred to as a base station 4.

The base station 4 is connected to the core network 3 via, for example, a signal line. The base station 4 is capable of wirelessly communicating with each of the terminal devices 5. More specifically, the base station 4 is capable of transmitting a radio signal (more precisely, a modulated signal) specified by the mobile communication system to each of the terminal devices 5. The base station 4 is capable of receiving a radio signal specified by the mobile communication system from each of the terminal devices 5. Therefore, the base station 4 may relay transfer of data between the core network 3 and each of the terminal devices 5.

Each of the terminal devices 5 is a wireless communication device conforming to the mobile communication system. The terminal devices 5 are, for example, M terminal devices 5-1, 5-2, . . . , and 5-M, where M is an integer of one or more. In the following, any one of the terminal devices 5 is also referred to as a terminal device 5.

The terminal device 5 is a device capable of wirelessly communicating with the base station 4. The terminal device 5 is also referred to as user equipment (UE). The terminal device 5 is realized as, for example, a mobile communication terminal such as a smartphone, a target device controlled by industrial robotics, an Internet of Things (IoT) device, an automatically running vehicle, or a robot. The automatically running vehicle is, for example, an automated guided vehicle (AGV). The terminal device 5 may be moved, for example, by being carried by a user or being incorporated into the automatically running vehicle, the robot, or the like. Note that the terminal device 5 may be fixed to a specific location. The terminal device 5 is capable of transmitting, to the base station 4, a radio signal specified by the mobile communication system. The terminal device 5 is capable of receiving, from the base station 4, a radio signal specified by the mobile communication system.

In the following, data transmitted from the terminal device 5 to the base station 4 is referred to as uplink data. The uplink data is, for example, data transmitted from the terminal device 5 to the server 2 via the base station 4 and the core network 3. Communication in which data is transmitted from the terminal device 5 to the base station 4 is referred to as uplink communication. The uplink communication is, for example, communication in which data is transmitted from the terminal device 5 to the server 2 via the base station 4 and the core network 3.

Data transmitted from the base station 4 to the terminal device 5 is referred to as downlink data. The downlink data is, for example, data transmitted from the server 2 to the terminal device 5 via the base station 4 and the core network 3. Communication in which data is transmitted from the base station 4 to the terminal device 5 is referred to as downlink communication. The downlink communication is, for example, communication in which data is transmitted from the server 2 to the terminal device 5 via the base station 4 and the core network 3.

The terminal device 5 can execute applications in cooperation with the server 2.

In one application, the terminal device 5 generates uplink data and transmits the uplink data to the base station 4. The base station 4 transmits the uplink data to the server 2 via the core network 3. The server 2 generates downlink data based on the uplink data and transmits the downlink data to the base station 4 via the core network 3. The base station 4 transmits the downlink data to the terminal device 5.

The terminal device 5 executing the application is, for example, a target device controlled by industrial robotics. In this case, the uplink data is, for example, data (sensor data) output from a sensor installed in the target device. The downlink data is, for example, a control signal that controls an operation of the target device. The server 2 generates the control signal based on the sensor data and transmits the control signal to the terminal device 5.

In another application, the server 2 generates downlink data and transmits the downlink data to the base station 4 via the core network 3. The base station 4 transmits the downlink data to the terminal device 5. The terminal device 5 generates uplink data based on the downlink data and transmits the uplink data to the base station 4. The base station 4 transmits the uplink data to the server 2 via the core network 3.

The terminal device 5 executing the other application is, for example, an IoT device including a sensor. In this case, the downlink data is, for example, a signal requesting the IoT device to transmit sensor data. The uplink data is, for example, sensor data. The terminal device 5 transmits the sensor data to the server 2 in response to the signal requesting the transmitting of the sensor data.

Here, allocation of resources related to wireless communication (communication resources) by the base station 4 will be described.

The base station 4 includes a scheduler 40. The scheduler 40 controls allocation of communication resources for both the downlink communication from the base station 4 to the terminal device 5 and the uplink communication from the terminal device 5 to the base station 4, in the network specified by the mobile communication system. The communication resources are, for example, a combination including at least two of frequency, time, space (spatial stream), antenna, power, code, and orbital angular momentum (OAM).

The base station 4 is capable of transmitting, to the terminal device 5, a control signal (control information) related to communication with the terminal device 5. The control signal transmitted from the base station 4 to the terminal device 5 is, for example, downlink control information (DCI). The DCI is control information that includes information on allocation of a communication resource, modulation, coding rate, and the like. The DCI is transmitted, for example, in a downlink control channel (physical downlink control channel: PDCCH) specified in the 3GPP. The base station 4 transmits, to the terminal device 5, allocation information (SchedulingRequest_config) indicative of communication resources allocated for transmitting scheduling requests (SRs), for example, in response to detecting a connection with the terminal device 5. Each scheduling request is a signal requesting allocation of a communication resource for uplink data transmitting. Scheduling means allocation of communication resources. The communication resources allocated for transmitting scheduling requests are, for example, resources of an uplink control channel (physical uplink control channel: PUCCH) specified in the 3GPP. In the following, the communication resources allocated for transmitting of scheduling requests are also referred to as slots for transmitting scheduling requests (SR transmitting slots). The allocation information includes information indicative of a cycle at which an SR transmitting slot is allocated (e.g., once every 10 milliseconds starting at a certain time), a frequency used for transmitting, and a series of codes used for transmitting.

The terminal device 5 is capable of transmitting, to the base station 4, a control signal related to communication with the base station 4. The control signal transmitted from the terminal device 5 to the base station 4 is, for example, a scheduling request. The terminal device 5 transmits the scheduling request to the base station 4 by using an SR transmitting slot.

In response to receiving the scheduling request, the scheduler 40 of the base station 4 allocates, to the terminal device 5, a communication resource for uplink data transmitting. The allocated communication resource is, for example, a resource of an uplink data communication channel (physical uplink shared channel: PUSCH) specified in the 3GPP. The base station 4 transmits DCI indicative of the allocated communication resource to the terminal device 5.

The terminal device 5 transmits uplink data to the base station 4 by using the communication resource indicated in the DCI received from the base station 4. In this manner, by using the communication resource allocated by the base station 4 in response to the scheduling request, the terminal device 5 can transmit the uplink data to the base station 4.

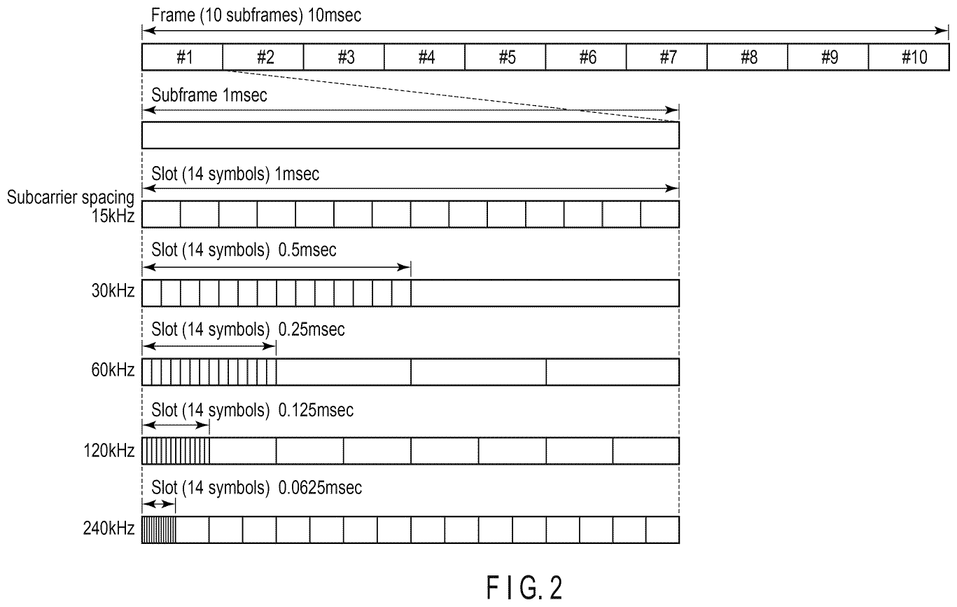

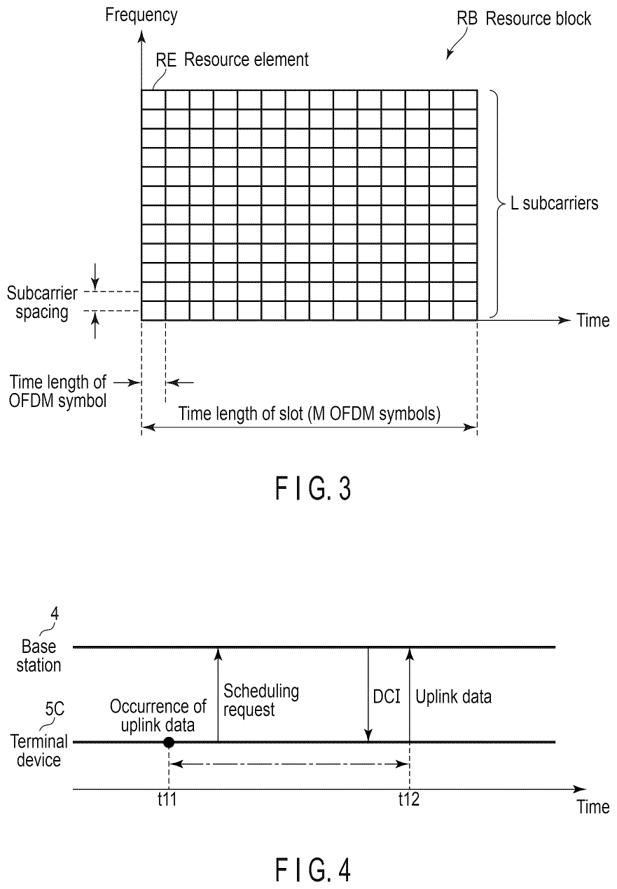

The communication resources will be explained with reference to FIG. 2 and FIG. 3.

FIG. 2 illustrates an example of a frame configuration in a radio signal transferred between the terminal device 5 and the base station 4.

The time length of a frame is predetermined in the mobile communication system (e.g., 5G system). The frame is a data signal (or data signals) having a length that corresponds to the predetermined time length. The time length of the frame corresponds to, for example, an operation cycle of coding/decoding regarding a modulated signal. The time length of a frame is, for example, 10 milliseconds (msec). One frame includes ten subframes.

The time length of a subframe is predetermined in the mobile communication system. The time length of a subframe is, for example, 1 millisecond. One subframe includes one or more slots.

A slot is a unit of scheduling of data transfer. The slot is composed of 14 orthogonal frequency division multiplexing (OFDM) symbols, regardless of a subcarrier spacing. An OFDM scheme is a modulation scheme capable of transferring data in parallel on multiple carrier waves that are orthogonal. Each of the carrier waves is referred to as a subcarrier. The time length of an OFDM symbol varies depending on the subcarrier spacing. Accordingly, the time length of a slot (slot length) varies depending on the subcarrier spacing. The subcarrier spacing is determined, for example, by the base station 4. Thus, the time length of an OFDM symbol and the slot length are determined by the base station 4.

The subcarrier spacing is specified by the mobile communication system. For example, the 5G system defines five types of subcarrier spacing. The five types of subcarrier spacing are 15 kHz (μ=0), 30 kHz (μ=1), 60 kHz (μ=2), 120 kHz (μ=3), and 240 kHz (μ=4). Note that u is a value for identifying a subcarrier spacing.

As shown in FIG. 2, in a case where the subcarrier spacing is 15 kHz, one subframe includes one slot. In a case where the subcarrier spacing is 30 kHz, one subframe includes two slots. In a case where the subcarrier spacing is 60 kHz, one subframe includes four slots. In a case where the subcarrier spacing is 120 kHz, one subframe includes eight slots. In a case where the subcarrier spacing is 240 kHz, one subframe includes 16 slots.

The smaller the subcarrier spacing, the longer the slot length. In other words, the larger the subcarrier spacing, the shorter the slot length. Specifically, for example, in a case where the subcarrier spacing is 15 kHz, the slot length is 1 msec. In a case where the subcarrier spacing is 30 kHz, the slot length is 0.5 msec. In a case where the subcarrier spacing is 60 kHz, the slot length is 0.25 msec. In a case where the subcarrier spacing is 120 kHz, the slot length is 0.125 msec. In a case where the subcarrier spacing is 240 kHz, the slot length is 0.0625 msec.

In a case where the subcarrier spacing is small and the slot length is long (e.g., in a case where the subcarrier spacing is 15 kHz and the slot length is 1 msec), it is strong against multipath but latency is long. On the other hand, in a case where the subcarrier spacing is large and the slot length is short (e.g., in a case where the subcarrier spacing is 240 kHz and the slot length is 0.0625 msec), latency is short but susceptibility to inter symbol interference (ISI) is increased.

Thus, for example, the terminal device 5 that moves at low speed and performs data transfer with a long tolerable latency is preferably allocated to a communication block with a small subcarrier spacing. In contrast, for example, the terminal device 5 that moves at high speed and performs data transfer with a short tolerable latency is preferably allocated to a communication block with a large subcarrier spacing.

A communication block is a unit of communication resources identified by a position in a frequency direction and a position in a time direction, in a radio signal. The radio signal includes a plurality of communication blocks. Each of the communication blocks is, for example, a resource element, a resource block, or a resource block group.

FIG. 3 illustrates an example of the communication resources. In FIG. 3, a vertical axis indicates frequency and a horizontal axis indicates time.

The mobile communication system defines a unit including M OFDM symbols as a slot, where M is, for example, 14.

In the mobile communication system, a resource element RE is a unit that includes one subcarrier and one OFDM symbol. One resource element RE is identified by a subcarrier position indicating a position in the frequency direction and a symbol position indicating a position in the time direction, in the modulated signal.

A resource block RB is a unit includes L subcarriers and one slot, where L is, for example, 12. One resource block RB includes a plurality of resource elements REs. For example, in a case where the resource block includes 12 subcarriers and one slot (i.e., 14 OFDM symbols), the resource block RB includes 168 (=12×14) resource elements REs. Note that the subcarrier spacing is changeable for each resource block RB.

A resource block group is a unit in which a plurality of resource blocks RBs are grouped. For example, in a case where a band of 100 MHz width is used as the modulated signal of the 5G system, one subframe includes 17 resource block groups.

The scheduler 40 of the base station 4 determines allocation of such communication resources to the terminal device 5. The scheduler 40 determines allocation of a communication resource, for example, in response to a scheduling request. The terminal device 5 may transmit data to the base station 4 by using the allocated communication resource.

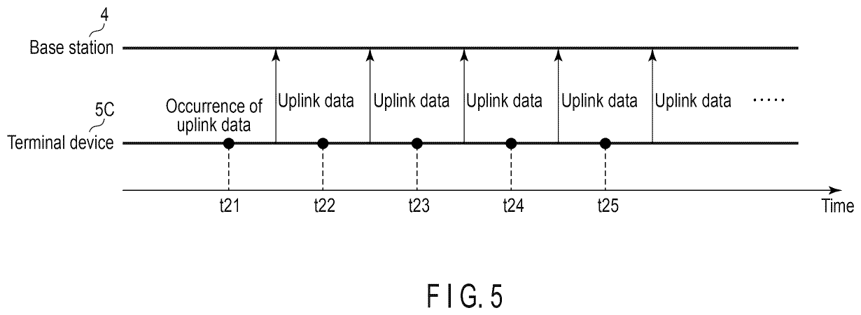

Here, with reference to FIG. 4 and FIG. 5, an occurrence of uplink data and transmitting of a scheduling request in a terminal device 5C according to a comparative example will be described.

FIG. 4 illustrates a flow from an occurrence to transmitting of uplink data in the terminal device 5C of the comparative example. Here, it is assumed that the uplink data to be transmitted to the base station 4 occurs in the terminal device 5C at a time t11.

In response to the occurrence of the uplink data, the terminal device 5C transmits a scheduling request to the base station 4 with use of the first SR transmitting slot later than the time t11.

In response to receiving the scheduling request from the terminal device 5C, the base station 4 allocates, to the terminal device 5C, a communication resource for uplink data transmitting. Then, the base station 4 transmits DCI indicative of the allocated communication resource to the terminal device 5C.

The terminal device 5C transmits the uplink data to the base station 4 at a time t12 by using the 25 allocated communication resource for uplink data transmitting (PUSCH), based on the DCI received from the base station 4.

Thus, in the terminal device 5C of the comparative example, there is latency (waiting time) from the time t11 to the time t12 in a period between the occurrence of the uplink data and the transmitting of the uplink data to the base station 4. In the terminal device 5C, a delay in the transmitting of the uplink data occurs because the process of transmitting the scheduling request to the base station 4 and receiving the DCI is performed after the occurrence of the uplink data.

Therefore, for example, in the 5G system, a configured grant suitable for uplink data transmitting that occurs at a fixed cycle is specified. In the configured grant, slots for uplink data transmitting having fixed time intervals are allocated in advance to the terminal device 5C. When uplink data has occurred, the terminal device 5C transmits the uplink data to the base station 4 by using one of the allocated slots for uplink data transmitting without transmitting a scheduling request.

FIG. 5 illustrates an occurrence and transmitting of uplink data at a fixed cycle in the terminal device 5C according to the comparative example.

In the terminal device 5C, uplink data occurs at the fixed cycle. Specifically, in the terminal device 5C, pieces of uplink data occur at times t21, t22, t23, t24, and t25, which have a fixed time interval.

The terminal device 5C, for example, transmits the uplink data that has occurred at the time t21 to the base station 4 by using the first slot for uplink data transmitting later than the time t21, allocated by the configured grant. The terminal device 5C transmits the uplink data that has occurred at each of the other times in the same way to the base station 4 by using the slot for uplink data transmitting allocated by the configured grant.

As a result, the terminal device 5C of the comparative example can transmit the pieces of uplink data to the base station 4 by using the slots for uplink data transmitting allocated by the configured grant, without performing the process of transmitting a scheduling request to the base station 4 and receiving DCI after each of the pieces of uplink data occurs. Therefore, in the terminal device 5C of the comparative example shown in FIG. 5, latency from when uplink data occurs until it is transmitted to the base station 4 can be shorter than that of the terminal device 5C of the comparative example shown in FIG. 4.

However, it may not be possible to shorten the latency from when uplink data occurs until it is transmitted to the base station 4 even by using the slots for uplink data transmitting allocated by the configured grant unless the pieces of uplink data occur at the fixed cycle.

Therefore, the terminal device 5 according to the first embodiment predicts a time when uplink data will occur next, and based on the predicted time, transmits a scheduling request to the base station 4 before uplink data actually occurs. The occurrence of uplink data means, for example, that a specific amount (size) of data to be transmitted from the terminal device 5 to the base station 4 has been generated. The terminal device 5 finds regularity in occurrences of uplink data by analyzing, for example, past time-series data related to communication between the base station 4 and the terminal device 5 and the state of the terminal device 5, and based on the regularity, generates a calculation formula (function) or a learning model to predict a time when uplink data will occur next. By the calculation formula based on the regularity, a time when uplink data will occur next is calculated. By the learning model in which the regularity has been learned, a time when uplink data will occur next is generated. The learning model is, for example, a mathematical model or a physical model. The terminal device 5 predicts a time when uplink data will occur next by using the generated calculation formula or the learning model. In the following, the time when uplink data will occur (or occurs) is also referred to as a UL data occurrence time.

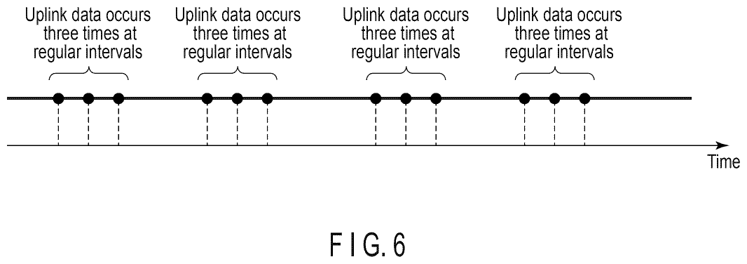

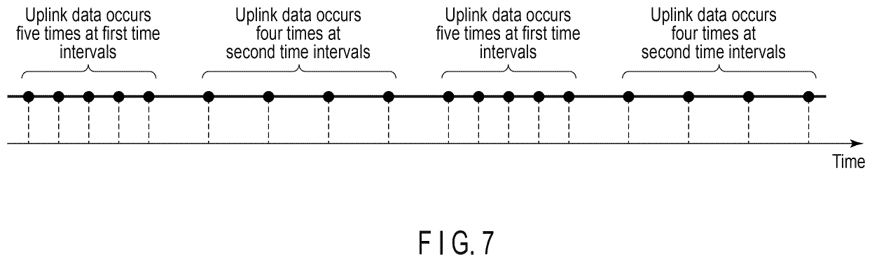

Cases where pieces of uplink data regularly occur will be described with reference to FIG. 6 and FIG. 7.

FIG. 6 illustrates an example in which pieces of uplink data regularly occur. In the example illustrated in FIG. 6, occurrences of three pieces of uplink data at time intervals are repeated. In other words, this example of uplink data occurrences indicates that uplink data regularly occur, although not at a fixed cycle.

FIG. 7 illustrates another example in which pieces of uplink data regularly occur. In the example illustrated in FIG. 7, occurrences of five pieces of uplink data at first time intervals and occurrences of four pieces of uplink data at second time intervals different from the first time intervals are repeated alternately. In other words, this example of uplink data occurrences indicates that uplink data regularly occur, although not at a fixed cycle.

Not only in each case where the occurrences of uplink data have simple regularity as illustrated in FIG. 6 and FIG. 7, but also in a case where they have complex regularity, the terminal device 5 predict a UL data occurrence time by using the calculation formula or the learning model obtained by analyzing data (e.g., time-series data) related to the communication between the base station 4 and the terminal device 5 and the state of the terminal device. In the terminal device 5, there are rules related to the occurrences of uplink data such as (1) uplink data is generated frequently while the terminal device 5 moves along a curved path, (2) uplink data is generated frequently while another terminal device 5 is located nearby (i.e., while the risk of collision is high), (3) different types of uplink data occur, and (4) uplink data occur at a frequency that varies depending on a moving speed of the terminal device 5. The terminal device 5 finds the regularity in accordance with such rules by analyzing time-series data related to the communication between the base station 4 and the terminal device 5 and the state of the terminal device 5, and predicts the next UL data occurrence time.

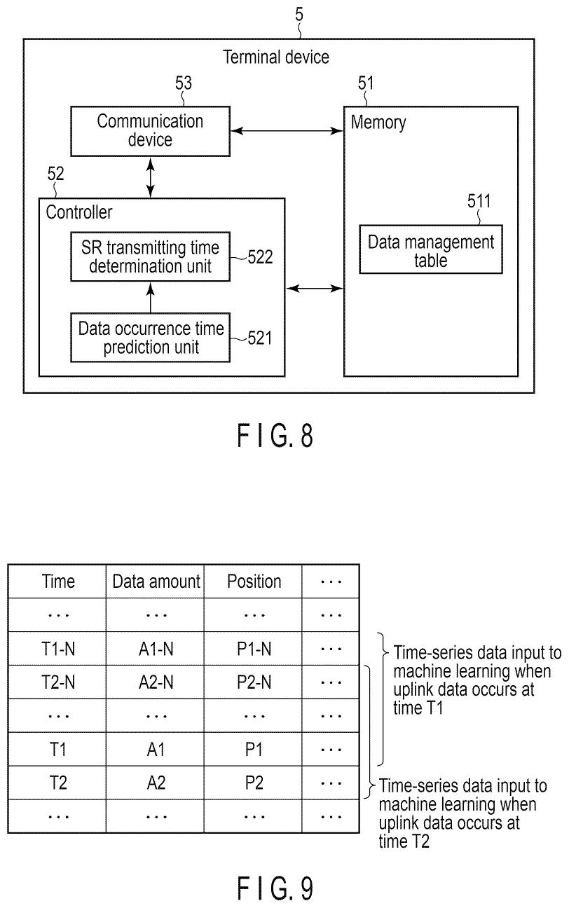

FIG. 8 is a block diagram illustrating an example of a configuration of the terminal device 5. The terminal device 5 includes a memory 51, a controller 52, and a communication device 53.

The memory 51 is a memory device that stores data used in the terminal device 5. The memory 51 is, for example, a random access memory (RAM). The memory 51 stores, for example, a data management table 511.

The data management table 511 is a table for managing data related to the communication between the terminal device 5 and the base station 4 and the state of the terminal device 5. The data related to the communication between the terminal device 5 and the base station 4 and the state of the terminal device 5 is also referred to as communication/state data. A specific configuration example of the data management table 511 will be described below with reference to FIG. 9.

The controller 52 controls a timing of transmitting a scheduling request. The controller 52 includes a data occurrence time prediction unit 521 and a scheduling request transmitting time determination unit (SR transmitting time determination unit) 522.

The data occurrence time prediction unit 521 predicts the next UL data occurrence time by using the communication/state data of the terminal device 5. The communication/state data is, for example, time-series data. The communication/state data may be managed in association with a time at which the data is acquired. The communication/state data used by the data occurrence time prediction unit 521 includes, for example, at least one of the following corresponding to the terminal device 5: slice information, the amount and a receiving time of downlink data received from the base station 4 in the past, the amount and a transmitting time of uplink data transmitted to the base station 4 in the past, a channel quality indicator (CQI), quality of experience (QoE), quality of service (QOS), reference signal received power (RSRP), reference signal received quality (RSRQ), an error rate, a received signal strength indicator (RSSI), a route map, a radio map, or a used frequency.

The slice information indicates wireless communication requirements corresponding to the terminal device 5. The slice information indicates, for example, one of ultra-reliable and low latency communications (URLLC), enhanced mobile broadband (eMBB), and massive machine type communication (mMTC). In URLLC, ultra-reliable and low latency wireless communications are required. In eMBB, high-speed and high-capacity wireless communications are required. In mMTC, wireless communications in which massive terminals are simultaneously connected are required. Note that the slice information currently specified in the 3GPP is only URLLC, eMBB, and mMTC; however, a vendor may set its own slice information. Therefore, the slice information may indicate the own information set in accordance with Qos, etc. For example, the slice information is received from the base station 4 and stored in the memory 51 by the communication device 53.

The amount and the receiving time of downlink data received from the base station 4 in the past indicate the amount of downlink data that was received by the terminal device 5 from the base station 4 and its receiving time. The amount and the receiving time of downlink data received from the base station 4 in the past are obtained and stored in the memory 51 by the communication device 53.

The amount and the transmitting time of uplink data transmitted to the base station 4 in the past indicate the amount of uplink data that was transmitted by the terminal device 5 to the base station 4 and its transmitting time. The amount and the transmitting time of uplink data transmitted to the base station 4 are obtained and stored in the memory 51 by the communication device 53.

CQI is a receiving quality indicator of a propagation path status of downlink. CQI is, for example, measured and stored in the memory 51 by the communication device 53.

QoE is an indicator of experience quality of communication. QoE is degraded by, for example, disruption of radio signals during communication or a handover failure. QoE is, for example, measured and stored in the memory 51 by the communication device 53.

Qos is an indicator of service quality of communication. QoS is, for example, measured and stored in the memory 51 by the communication device 53.

RSRP is the received power of a reference signal. RSRP is, for example, measured and stored in the memory 51 by the communication device 53.

RSRQ is the received quality of a reference signal. RSRQ is, for example, measured and stored in the memory 51 by the communication device 53.

The error rate is an error rate of data transferred between the terminal device 5 and the base station 4. The error rate is obtained, for example, based on error detection/correction processing for received data. The error rate may also be obtained based on a response (ACK) to transmitted data. The error rate is, for example, obtained and stored in the memory 51 by the communication device 53.

RSSI is the strength of a received signal. RSSI is, for example, measured and stored in the memory 51 by the communication device 53.

The route map is information indicating locations (positions) where the terminal device 5 have passed. The route map may be information in which a map showing locations of paths (roads), objects, etc., is associated with the locations where the terminal device 5 have passed. With such a route map, it is possible to recognize the state of the terminal device 5, for example, that the terminal device 5 is moving along a straight path or that it is moving along a curved path. The route map may also include information indicating locations where the terminal device 5 will pass. The route map is generated by the terminal device 5 (e.g., an application program executed in the terminal device 5) or received from the base station 4 and stored in the memory 51 by the communication device 53.

The radio map is information indicating radio field intensity in the vicinity of the terminal device 5. The radio map may be information in which a map showing locations of paths, objects, etc., is associated with the radio field intensity. The radio map is generated by the communication device 53 or is received from the base station 4 and stored in the memory 51 by the communication device 53.

The used frequency indicates a frequency (frequency band) used for communication between the terminal device 5 and the base station 4. The used frequency is, for example, a millimeter wave frequency band. Information indicating the used frequency is received from the base station 4 and stored in the memory 51 by the communication device 53, for example.

The data occurrence time prediction unit 521 predicts a UL data occurrence time by using the calculation formula or the learning model obtained by analyzing the time-series communication/state data of the terminal device 5. Specifically, the data occurrence time prediction unit 521 predicts the next UL data occurrence time by using, for example, machine learning to which the time-series communication/state data of the terminal device 5 is input. As the machine learning, for example, a recurrent neural network or Transformer is used. Even in a case where occurrences of uplink data in the terminal device 5 are not at a fixed cycle, in a case where there is some regularity in the occurrences of uplink data, the data occurrence time prediction unit 521 can accurately predict the UL data occurrence time by analysis, such as machine learning.

The data occurrence time prediction unit 521 transmits the predicted UL data occurrence time to the SR transmitting time determination unit 522.

The SR transmitting time determination unit 522 determines a scheduling request transmitting time (SR transmitting time) on the basis of the UL data occurrence time received from the data occurrence time prediction unit 521. The SR transmitting time is a time before the next uplink data actually occurs. The SR transmitting time determination unit 522 uses, for example, the UL data occurrence time and the communication/state data of the terminal device 5 to determine the SR transmitting time. The communication/state data used by the SR transmitting time determination unit 522 includes, for example, at least one of the following corresponding to the terminal device 5: a cycle at which an SR transmitting slot is allocated, the current time, a duration from transmitting a scheduling request until receiving DCI in the past, the amount of a communication resource allocated by the base station 4 in the past, slice information, the amount and a receiving time of downlink data received from the base station 4 in the past, the amount and a transmitting time of uplink data transmitted to the base station 4 in the past, CQI, QOE, QOS, RSRP, RSRQ, an error rate, RSSI, a route map, a radio map, or a used frequency.

The cycle at which an SR transmitting slot is allocated is based on the allocation information (SchedulingRequst_config) received from the base station 4, for example. The cycle at which an SR transmitting slot is allocated is, for example, obtained from the allocation information and stored in the memory 51 by the communication device 53.

The duration from transmitting a scheduling request until receiving DCI is, more specifically, a duration from when a scheduling request is transmitted until DCI that indicates a communication resource for uplink data transmitting allocated in response to the scheduling request is received. The duration from transmitting a scheduling request until receiving DCI is also referred to as an allocation process duration. The allocation process duration is, for example, obtained and stored in the memory 51 by the communication device 53.

The amount of a communication resource allocated by the base station 4 in the past is the amount of a communication resource (or communication resources) allocated to the terminal device 5 by the base station 4 in the past. The amount of a communication resource allocated by the base station 4 in the past is, for example, obtained and stored in the memory 51 by the communication device 53.

The SR transmitting time determination unit 522 estimates the next allocation process duration by using, for example, the allocation process duration(s) in the past. The SR transmitting time determination unit 522 calculates, for example, an average time of the past allocation process durations as the next allocation process duration. The SR transmitting time determination unit 522 calculates a time by subtracting the estimated next allocation process duration from the UL data occurrence time, and identifies the first SR transmitting slot that is later than the calculated time on the basis of the cycle at which an SR transmitting slot is allocated. Then, the SR transmitting time determination unit 522 determines a time corresponding to the identified SR transmitting slot (e.g., the start time of the SR transmitting slot) as the SR transmitting time.

Note that the SR transmitting time determination unit 522 may also use the previous allocation process duration as the next allocation process duration. The SR transmitting time determination unit 522 may also calculate a weighted average of the past allocation process durations, with the weight to each past allocation process duration being larger the closer the allocation process duration is to the current time. Alternatively, the SR transmitting time determination unit 522 may estimate the next allocation process duration by analysis (e.g., machine learning) using the time-series communication/state data of the terminal device 5. Furthermore, the SR transmitting time determination unit 522 may adjust the next allocation process duration according to the QoS (e.g., acceptable delay time) of the terminal device 5 based on the slice information.

The SR transmitting time determination unit 522 notifies the communication device 53 of the determined SR transmitting time. The SR transmitting time determination unit 522 may notify the communication device 53 of the identified SR transmitting slot (more specifically, an index assigned to the SR transmitting slot).

The communication device 53 executes wireless communication with the base station 4 via an antenna. Specifically, the communication device 53 performs transmitting (radiating) a radio signal to the base station 4, receiving a radio signal from the base station 4, generating a signal, various processes on a signal, etc.

The communication device 53 may obtain the communication/state data of the terminal device 5 and store the data in the memory 51 (specifically, for example, in the data management table 511). The communication/state data obtained by the communication device 53 includes, for example, at least one of the following: slice information, the amount and a receiving time of downlink data received from the base station 4 in the past, the amount and a transmitting time of uplink data transmitted to the base station 4 in the past, COI, QOE, QOS, RSRP, RSRQ, an error rate, RSSI, a route map, a radio map, a used frequency, a cycle at which an SR transmitting slot is allocated, a duration from transmitting a scheduling request until receiving DCI in the past, or the amount of a communication resource allocated by the base station 4 in the past.

When the SR transmitting time determination unit 522 has notified the communication device 53 of the SR transmitting time (SR transmitting slot), the communication device 53 generates a scheduling request. Then, the communication device 53 transmits the scheduling request to the base station 4 at that SR transmitting time (by using that SR transmitting slot). Specifically, the communication device 53 radiates a radio signal for the base station 4 including the scheduling request via the antenna.

The communication device 53 receives, from the base station 4, DCI indicative of a communication resource allocated for uplink data transmitting. The communication device 53 transmits uplink data to the base station 4 by using the communication resource indicated in the DCI. Specifically, the communication device 53 radiates a radio signal for the base station 4 including the uplink data via the antenna.

Here, with reference to FIG. 9, an example of a configuration of the data management table 511 and prediction of a UL data occurrence time using the data management table 511 will be described.

FIG. 9 illustrates an example of a configuration of the data management table 511. The data management table 511 includes, for example, entries that correspond to times, respectively. Each of the entries includes, for example, a time field, a data amount field, and a position field.

In an entry corresponding to a time, the time field indicates the time (e.g., date and time). The data amount field indicates the amount of uplink data that occurs at the corresponding time. The position field indicates a position (i.e., route map) of the terminal device 5 at the corresponding time.

The data management table 511 is not limited to the configuration example illustrated in FIG. 9, and may have any configuration as long as it can manage data used for at least one of predicting a UL data occurrence time or determining an SR transmitting time.

The data management table 511 illustrated in FIG. 9 is used, for example, in the case of predicting a UL data occurrence time at the terminal device 5 that is an AGV. The terminal device 5 that is an AGV is set so that the frequency of occurrence of uplink data varies between a period in which the terminal device 5 runs along a straight path and a period in which the terminal device 5 runs along a curved path. This uplink data is, for example, data related to control of running of the AGV. For example, uplink data occurs more frequently during the period in which the AGV runs along a curved path than during the period in which it runs along a straight path. Therefore, for the terminal device 5 that is an AGV, the position (location) of the AGV (terminal device 5) has a significant impact on the UL data occurrence time.

In the example illustrated in FIG. 9, an entry corresponding to a time T1-N indicates that the amount of uplink data occurs in the terminal device 5 at the time T1-N is A1-N and that a position of the terminal device 5 at the time T1-N is P1-N. An entry corresponding to a time T2-N indicates that the amount of uplink data occurs in the terminal device 5 at the time T2-N is A2-N and that a position of the terminal device 5 at the time T2-N is P2-N. An entry corresponding to a time T1 indicates that the amount of uplink data occurs in the terminal device 5 at the time T1 is A1 and that a position of the terminal device 5 at the time T1 is P1. An entry corresponding to a time T2 indicates that the amount of uplink data occurs in the terminal device 5 at the time T2 is A2 and that a position of the terminal device 5 at the time T2 is P2. Note that N is a specific time. Therefore, the time T1-N is a time earlier than the time T1 by the time N. The time T2-N is a time earlier than the time T2 by the time N.

The data occurrence time prediction unit 521 predicts the next UL data occurrence time, for example, in response to an occurrence of uplink data. Specifically, for example, when uplink data has occurred at the time T1, the data occurrence time prediction unit 521 performs machine learning to which data (i.e., time, uplink data amount, and position) from the time T1-N to the time T1 in the data management table 511 is input and then predicts (generates) the next UL data occurrence time. Next, when uplink data has occurred at the time T2, the data occurrence time prediction unit 521 performs machine learning to which data from the time T2-N to the time T2 in the data management table 511 is input and then predicts the further next UL data occurrence time. In this manner, the data occurrence time prediction unit 521 predicts the UL data occurrence time sequentially.

Next, an example will be described in which the SR transmitting time determination unit 522 determines an SR transmitting time by using a UL data occurrence time predicted by the data occurrence time prediction unit 521.

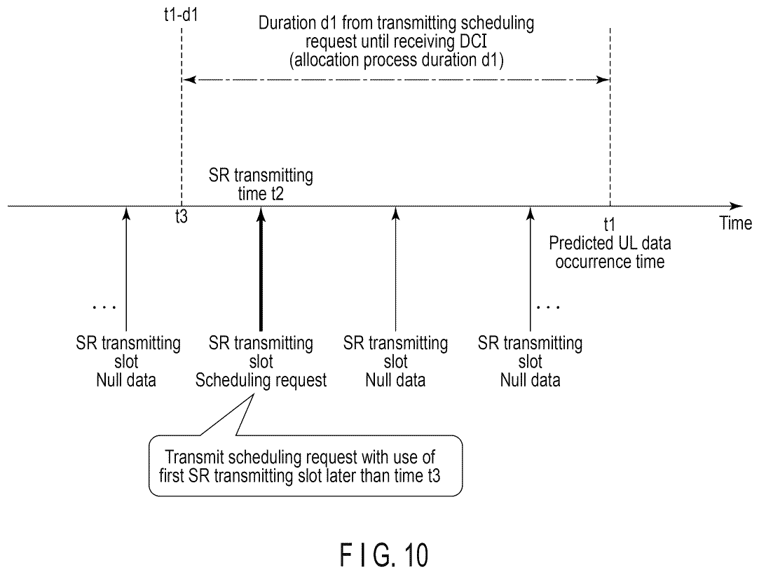

FIG. 10 illustrates an example of the SR transmitting time. In the following, a UL data occurrence time predicted by the data occurrence time prediction unit 521 is referred to as t1. A duration from transmitting a scheduling request until receiving DCI (allocation process duration) that is estimated by the SR transmitting time determination unit 522, is referred to as d1. The allocation process duration d1 is, for example, the average of durations each of which is a duration from transmitting a scheduling request until receiving DCI in the past.

The SR transmitting time determination unit 522 identifies, as an SR transmitting time t2, the first SR transmitting slot later than a time t3 which is obtained by subtracting the allocation process duration d1 from the UL data occurrence time t1. This is because if an SR transmitting slot earlier than the time t3 is used, there is a possibility that a communication resource corresponding to a time before a time when uplink data actually occurs is allocated to the terminal device 5.

The communication device 53 transmits a scheduling request to the base station 4 by using the SR transmitting slot at the SR transmitting time t2. By using a communication resource for uplink data transmitting allocated according to the transmitted scheduling request, the communication device 53 transmits uplink data that has occurred, to the base station 4.

Accordingly, the terminal device 5 can shorten latency from the occurrence to transmitting of the uplink data, compared to the terminal device 5C of the comparative example which transmits a scheduling request and receives DCI after uplink data actually occurs. Furthermore, even in a case where uplink data does not occur at a fixed cycle, the terminal device 5 can transmit the scheduling request to the base station 4 at the SR transmitting time t2 before the uplink data actually occurs, based on the predicted UL data occurrence time t1.

Note that, in a case where uplink data is estimated to be important data, the communication device 53 may transmit a plurality of scheduling requests to the base station 4 by using a plurality of SR transmitting slots that start with the SR transmitting slot at the SR transmitting time t2. In this case, the base station 4 allocates multiple communication resources for uplink data transmitting in response to the plurality of scheduling requests. This enables the communication device 53 to transmit the important uplink data to the base station 4 with low latency and with high reliability.

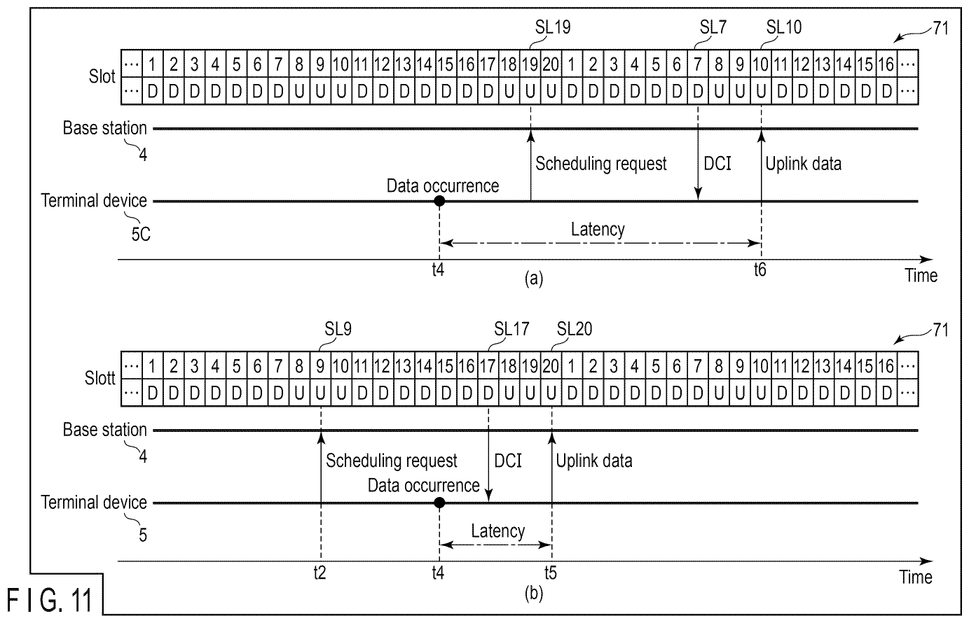

FIG. 11 illustrates (a) latency from an occurrence to transmitting of uplink data in the terminal device 5C according to the comparative example and (b) an example of latency from an occurrence to transmitting of uplink data in the terminal device 5 according to the first embodiment. Here, it is assumed that uplink data occurs at a time t4 in both the terminal device 5C and the terminal device 5. It is also assumed that the allocation process duration is the same for both cases of the terminal device 5C and the terminal device 5.

FIG. 11 illustrates contiguous slots 71 in a time domain that are allocated as communication resources. Each of the terminal device 5C and the terminal device 5 is capable of transferring data to and from the base station 4 by using at least one of the slots 71. The slots 71 have respective indexes each of which is assigned to identify the timing of the corresponding slot, for example. In the example illustrated in FIG. 11, the indexes from 1 to 20 are repeatedly assigned, starting from the first slot. The timing of a slot may correspond, for example, to its slot type. The slot type corresponds, for example, to the use assigned to that slot. Specifically, the slot type includes, for example, a type allocated for transmitting a scheduling request and a type allocated for transmitting DCI.

The slots 71 include a slot for downlink communication and a slot for uplink communication. In the example shown in FIG. 11, the slot for downlink communication is indicated by “D” and the slot for uplink communication is indicated by “U”. The slots 71 also include a slot for uplink communication allocated for transmitting a scheduling request (SR transmitting slot) and a slot for downlink communication allocated for transmitting DCI (DCI transmitting slot). Here, it is assumed that SR transmitting slots are the slots having the index “9” and the slots having the index “19”. In addition, it is assumed that DCI transmitting slots are the slots having the index “7” and the slots having the index “17”.

As shown in FIG. 11(a), when the uplink data has occurred at the time t4, the terminal device 5C of the comparative example transmits a scheduling request to the base station 4 by using the first SR transmitting slot SL19 which is later than the time t4.

In response to the scheduling request, the base station 4 generates DCI indicating that a slot SL10 of the index “10” is allocated as a slot (communication resource) for uplink data transmitting. Then, the base station 4 transmits the DCI to the terminal device 5C by using the first DCI transmitting slot SL7 after generating the DCI.

The terminal device 5C transmits the uplink data to the base station 4 by using the allocated slot SL10 for uplink data transmitting on the basis of the DCI received from the base station 4. The time at which the terminal device 5C transmits the uplink data to the base station 4 (i.e., the time corresponding to the slot SL10) is referred to as t6.

Thus, in the terminal device 5C, latency from the time t4 to the time t6 occurs in a period between the occurrence of the uplink data and the transmitting the uplink data.

In contrast, in FIG. 11(b), the terminal device 5 of the first embodiment transmits a scheduling request to the base station 4 at the SR transmitting time t2 before the time t4 when the uplink data actually occurs, by using an SR transmitting slot SL9 determined based on the predicted UL data occurrence time t1.

The base station 4 generates DCI indicating that a slot SL20 of the index “20” is allocated as a slot for uplink data transmitting in response to the scheduling request. Then, the base station 4 transmits the DCI to the terminal device 5 by using the first DCI transmitting slot SL17 after generating the DCI.

The terminal device 5 transmits the uplink data to the base station 4 by using the allocated slot SL20 for uplink data transmitting based on the DCI received from the base station 4. The time at which the terminal device 5 transmits the uplink data to the base station 4 (i.e., the time corresponding to the slot SL20) is referred to as t5. The time t5 is earlier than the time t6.

Therefore, the terminal device 5 of the first embodiment can transmit the uplink data to the base station 4 earlier than the terminal device 5C of the comparative example in a case where the uplink data occurs at the time t4. In the terminal device 5 of the first embodiment, latency from the time t4 to the time t5 occurs in a period between the occurrence of the uplink data and transmitting of the uplink data. Since the time t5 is earlier than the time t6, the latency from the time t4 to the time t5 in the terminal device 5 of the first embodiment is shorter than the latency from the time t4 to the time to in the terminal device 5C of the comparative example. Thus, the terminal device 5 of the first embodiment can shorten the latency from the occurrence to transmitting of the uplink data, compared to the terminal device 5C of the comparative example which transmits the scheduling request and receives the DCI after the uplink data actually occurs.

Next, a flow of an operation between the base station 4 and the terminal device 5 of the first embodiment will be described.

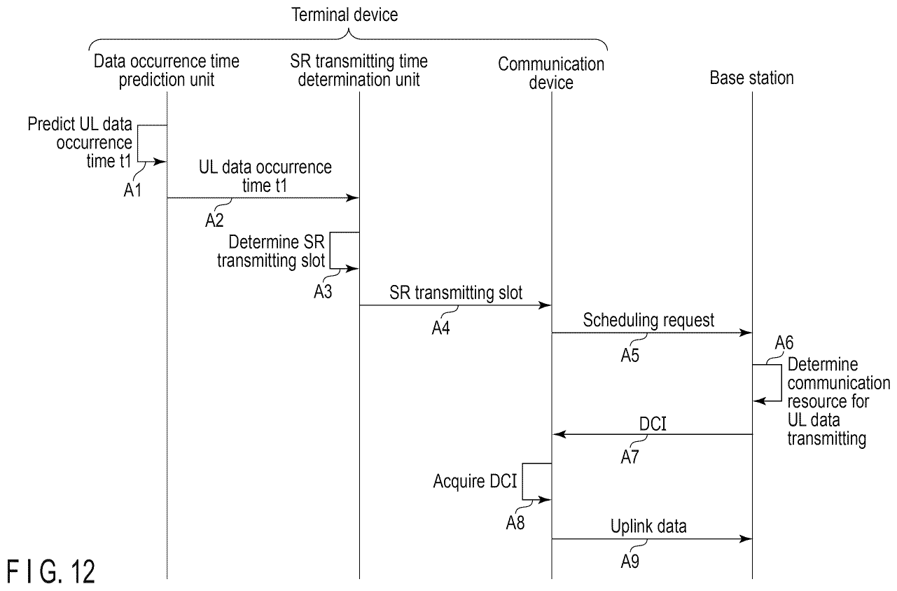

FIG. 12 is a sequence diagram illustrating an example of an operation for transmitting uplink data from the terminal device 5 to the base station 4. Here, it is assumed that the uplink data actually occurs between a time when the terminal device 5 transmits a scheduling request to the base station 4 and a time when the terminal device 5 receives DCI from the base station 4.

First, in the terminal device 5, the data occurrence time prediction unit 521 predicts the next UL data occurrence time t1 (A1). The data occurrence time prediction unit 521 sends the predicted UL data occurrence time t1 to the SR transmitting time determination unit 522 (A2).

The SR transmitting time determination unit 522 determines the first SR transmitting slot later than the UL data occurrence time t1 on the basis of the received UL data occurrence time t1 and the cycle at which the SR transmitting slot is allocated (A3). The SR transmitting time determination unit 522 notifies the communication device 53 of the determined SR transmitting slot (A4).

The communication device 53 transmits a scheduling request to the base station 4 by using the SR transmitting slot notified by the SR transmitting time determination unit 522 (A5).

In response to receiving the scheduling request from the terminal device 5, the base station 4 (more specifically, the scheduler 40) determines a communication resource for uplink data transmitting allocated to the terminal device 5 (A6). The base station 4 transmits DCI indicative of the determined communication resource to the terminal device 5 (A7).

The communication device 53 of the terminal device 5 receives a radio signal from the base station 4 via the antenna and acquires the DCI from the received radio signal (A8). The communication device 53 transmits uplink data to the base station 4 by using the communication resource indicated in the acquired DCI (A9).

By the above operation, based on the predicted UL data occurrence time t1, the terminal device 5 transmits the scheduling request to the base station 4 at a time before the uplink data actually occurs. Then, the terminal device 5 receives the DCI from the base station 4 indicative of the communication resource allocated in response to the scheduling request. This enables the terminal device 5 to shorten latency from the occurrence to transmitting of the uplink data, compared to the terminal device 5C of the comparative example that transmits a scheduling request and receives DCI after uplink data actually occurs. Therefore, the terminal device 5 can reduce the latency of uplink data transmitting.

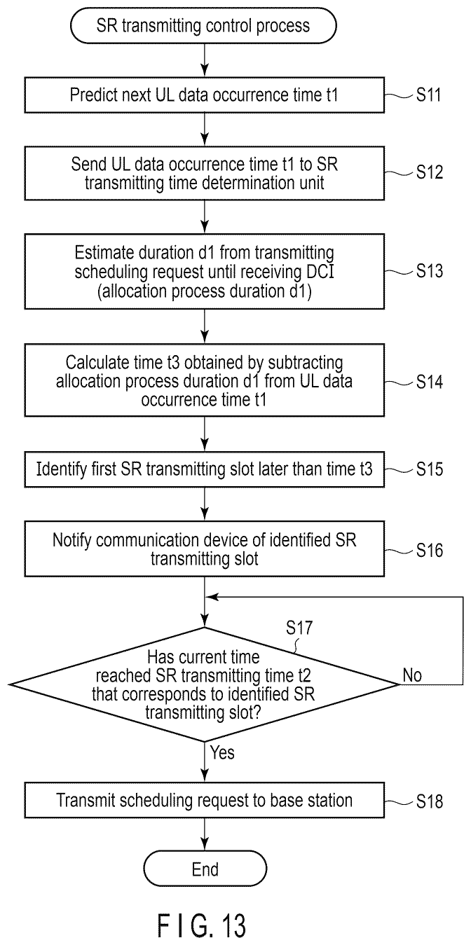

FIG. 13 is a flowchart illustrating an example of the procedure of a scheduling request transmitting control process (SR transmitting control process) executed in the terminal device 5. The SR transmitting control process is a process of predicting the next UL data occurrence time and controlling transmitting of a scheduling request to the base station 4. For example, the terminal device 5 executes the SR transmitting control process in response to an occurrence of uplink data.

In the terminal device 5, first, the data occurrence time prediction unit 521 predicts the next UL data occurrence time t1 (step S11). Specifically, the data occurrence time prediction unit 521 performs, for example, machine learning to which the communication/state data of the terminal device 5 is input and generates the next UL data occurrence time t1. The data occurrence time prediction unit 521 sends the predicted UL data occurrence time t1 to the SR transmitting time determination unit 522 (step S12).

The SR transmitting time determination unit 522 estimates a duration d1 from transmitting a scheduling request to the base station 4 until receiving DCI indicative of an allocated communication resource for uplink data transmitting from the base station 4 (allocation process duration d1) (step S13). The SR transmitting time determination unit 522 calculates a time t3 by subtracting the allocation process duration d1 from the UL data occurrence time t1 (step S14). The SR transmitting time determination unit 522 identifies the first SR transmitting slot that is later than the time t3 from the contiguous slots 71 in the time domain (step S15). The SR transmitting time determination unit 522 then notifies the communication device 53 of the identified SR transmitting slot (step S16).

The communication device 53 determines whether or not the current time has reached an SR transmitting time t2 corresponding to the identified SR transmitting slot (step S17). The SR transmitting time t2 is, for example, the start time of the identified SR transmitting slot.

When the current time has not reached the SR transmitting time t2 (No in step S17), the process by the communication device 53 returns to step S17. That is, the communication device 53 waits to transmit a scheduling request until the current time reaches the SR transmitting time t2.

When the current time has reached the SR transmitting time t2 (Yes in step S17), the communication device 53 transmits a scheduling request to the base station 4 (step S18) and ends the SR transmitting control process.

With the SR transmitting control process described above, the terminal device 5 can transmit the scheduling request to the base station 4 before uplink data actually occurs, based on the predicted UL data occurrence time t1. For example, the terminal device 5 predicts the UL data occurrence time t1 by using the machine learning with the communication/state data as input. This enables the terminal device 5 to transmit the scheduling request to the base station 4 before the uplink data actually occurs, based on the regularity of uplink data occurrence, for example, even in a case where uplink data does not occur at a fixed cycle.

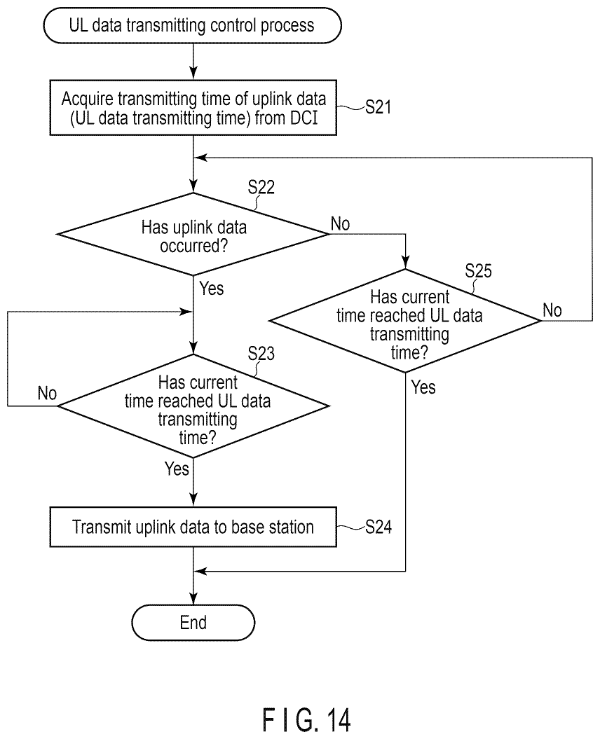

FIG. 14 is a flowchart illustrating an example of the procedure of an uplink data transmitting control process (UL data transmitting control process) executed in the terminal device 5. The UL data transmitting control process is a process of controlling transmitting of uplink data to the base station 4. For example, the terminal device 5 executes the UL data transmitting control process in response to acquiring DCI for a scheduling request. The DCI indicates a communication resource allocated for uplink data transmitting.

The communication device 53 of the terminal device 5 acquires a time at which uplink data is to be transmitted (UL data transmitting time), based on the communication resource for uplink data transmitting indicated in the DCI (step S21). Then, the communication device 53 determines whether or not uplink data has occurred (step S22).

When the uplink data has occurred (Yes in step S22), the communication device 53 determines whether or not the current time has reached the UL data transmitting time (step S23).

When the current time has not reached the UL data transmitting time (No in step S23), the process by the communication device 53 returns to step S23. That is, the communication device 53 waits to transmit the uplink data until the current time reaches the UL data transmitting time.

When the current time has reached the UL data transmitting time (Yes in step S23), the communication device 53 transmits the uplink data to the base station 4 by using the communication resource indicated in the DCI (step S24) and ends the UL data transmitting control process.

When no uplink data occurs (No in step S22), the communication device 53 determines whether or not the current time has reached the UL data transmitting time (step S25).

When the current time has not reached the UL data transmitting time (No in step S25), the process by the communication device 53 returns to step S22.

When the current time has reached the UL data transmitting time (Yes in step S25), the communication device 53 ends the UL data transmitting control process without transmitting uplink data because no uplink data has occurred by the UL data transmitting time.

With the above UL data transmitting control process, the terminal device 5 transmits uplink data that has occurred to the base station 4 at the UL data transmitting time based on the DCI. The UL data transmitting time is based on, for example, the DCI for the scheduling request that was transmitted before this uplink data actually occurs. Furthermore, the uplink data transmitted at the UL data transmitting time is, for example, uplink data that occurs after the terminal device 5 transmits the scheduling request and before the current time reaches the UL data transmitting time. Accordingly, the terminal device 5 can shorten the latency from the occurrence to transmitting of the uplink data, compared to the terminal device 5C of the comparative example that transmits a scheduling request and receives DCI after uplink data actually occurs. Therefore, the terminal device 5 can reduce the latency of uplink data transmitting.

### Second Embodiment

In the first embodiment, before uplink data actually occurs, a scheduling request, which requests allocation of a communication resource to the terminal device 5 for uplink data transmitting, is transmitted from the terminal device 5 to the base station 4. In contrast, in a second embodiment, a scheduling request, which requests allocation of a communication resource to a terminal device 5 for uplink data transmitting, is generated in a base station 4 before uplink data actually occurs.

A configuration of a communication system 1 of the second embodiment is similar to that of the communication system 1 of the first embodiment. The communication system 1 of the second embodiment is different from the communication system 1 of the first embodiment in terms of the configuration for generating a scheduling request is included in the base station 4, not in the terminal device 5. Hereinafter, the difference from the first embodiment will be mainly described.

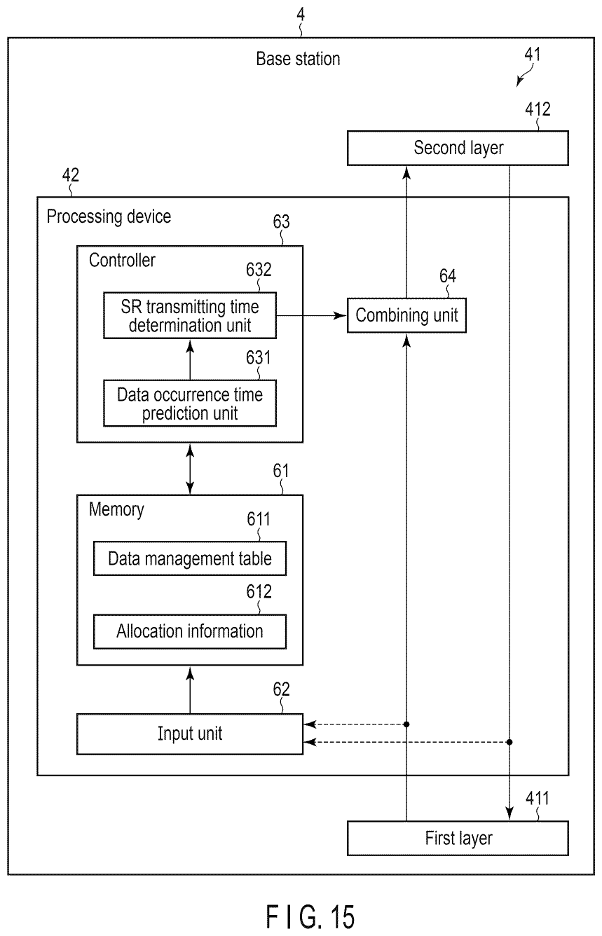

FIG. 15 is a block diagram illustrating an example of a configuration of the base station 4 according to the second embodiment.

The base station 4 includes multiple layers 41 and a processing device 42.

The layers 41 are functional units into which a function of the base station 4 is logically divided. The layers 41 include a first layer 411 and a second layer 412.

The first layer 411 may transmit a physical layer signal to the second layer 412. The physical layer signal transmitted from the first layer 411 to the second layer 412 is an uplink signal (UL signal). The physical layer signal corresponds, for example, to at least one of contiguous slots 71 in a time domain. The slots 71 include an SR transmitting slot.

The second layer 412 may transmit a signal to the first layer 411. The signal transmitted from the second layer 412 to the first layer 411 is a downlink signal (DL signal). The downlink signal is a generic term for downlink data and allocation information.

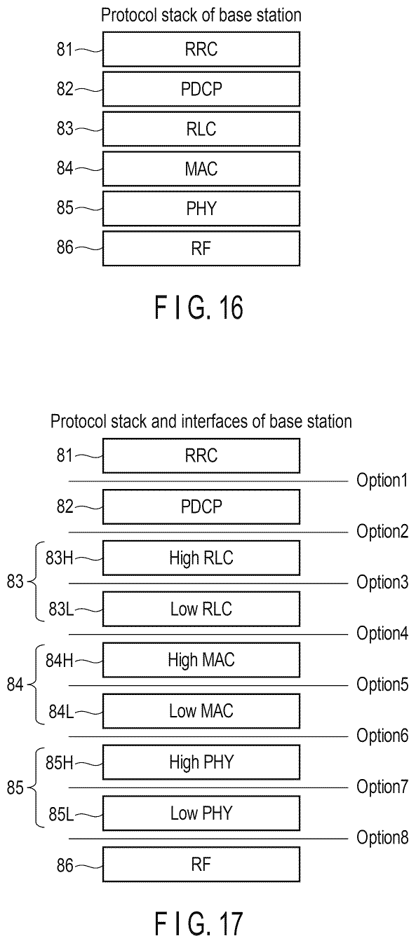

Specific examples of functions of the layers 41 will be described below with reference to FIG. 16 to FIG. 18.

The processing device 42 is a device that performs a specific signal process on an uplink signal transmitted from the first layer 411 to the second layer 412 and transmits the processed uplink signal to the second layer 412. Specifically, the processing device 42 generates a composite signal by combining (adding) a control signal including a scheduling request with (to) the uplink signal from the first layer 411, at a specific timing. The processing device 42 then transmits the composite signal to the second layer 412. This scheduling request is an allocation request of a communication resource for the terminal device 5 to transmit uplink data. Note that the processing device 42 does not perform any signal processes on a downlink signal transmitted from the second layer 412 to the first layer 411 and transmits that downlink signal to the first layer 411 as it is.

The processing device 42 is arranged at an interface between the first layer 411 and the second layer 412. The processing device 42 is connected to the first layer 411 and the second layer 412. Each of the connections between the processing device 42 and the first layer 411 and between the processing device 42 and the second layer 412 may be any of a wired connection, a wireless connection, and a logical connection.

The processing device 42 includes, for example, a memory 61, an input unit 62, a controller 63, and a combining unit 64.

The memory 61 is a memory device that stores data used in the processing device 42. The memory 61 is, for example, RAM. The memory 61 stores, for example, a data management table 611 and allocation information 612.

The data management table 611 is a table for managing communication/state data of the terminal device 5. A specific configuration example of the data management table 611 is similar to the data management table 511 described above with reference to FIG. 9.

The allocation information 612 is information indicative of a communication resource allocated for transmitting a scheduling request (or communication resources allocated for transmitting scheduling requests). Specifically, the allocation information 612 includes, for example, information indicative of a slot allocated as an SR transmitting slot among the contiguous slots 71 in the time domain.

The input unit 62 is an input device that generates data (information) in accordance with an operation by an operator of the base station 4 or receives data generated externally. The information generated or received by the input unit 62 is referred to as input information. The input unit 62 may store the input information in the memory 61. The input information includes, for example, the data management table 611 and the allocation information 612.

Specifically, the input unit 62 stores (adds), for example, data generated in accordance with an operation by an operator of the base station 4 to the data management table 611. Alternatively, the input unit 62 may store at least one of data acquired from the first layer 411 or data acquired from the second layer 412 in the data management table 611.

The input unit 62 also generates the allocation information 612, for example, in accordance with an operation by an operator of the base station 4. Alternatively, the input unit 62 may acquire the allocation information 612 from either the first layer 411 or the second layer 412. The input unit 62 stores the generated or acquired allocation information 612 in the memory 61.

The controller 63 controls a timing of transmitting a scheduling request. The controller 63 includes a data occurrence time prediction unit 631 and an SR transmitting time determination unit 632.

The operation by the data occurrence time prediction unit 631 is similar to the operation of the data occurrence time prediction unit 521 in the terminal device 5 of the first embodiment, except that the data occurrence time prediction unit 631 sends a UL data occurrence time to the SR transmitting time determination unit 632 instead of the SR transmitting time determination unit 522. That is, the data occurrence time prediction unit 631 predicts the next UL data occurrence time by using the communication/state data of the terminal device 5 (e.g., the data management table 611), and sends the predicted UL data occurrence time to the SR transmitting time determination unit 632.

An operation by the SR transmitting time determination unit 632 is similar to the operation of the SR transmitting time determination unit 522 in the terminal device 5 of the first embodiment, except that the SR transmitting time determination unit 632 notifies the combining unit 64 of an SR transmitting time instead of the communication device 53. That is, the SR transmitting time determination unit 632 determines an SR transmitting time (SR transmitting slot) by using the communication/state data of the terminal device 5 (e.g., the data management table 611 and the allocation information 612) and the UL data occurrence time, and notifies the combining unit 64 of the determined SR transmitting time. Determining the SR transmitting time corresponds, for example, to identifying the first SR transmitting slot that is later than a time obtained by subtracting an estimated allocation process duration from the UL data occurrence time.

The combining unit 64 generates a composite signal by combining (adding) a control signal including a scheduling request with (to) a physical layer signal transmitted from the first layer 411 to the second layer 412 at a time before uplink data actually occurs in the terminal device 5, based on the SR transmitting time (SR transmitting slot) notified by the SR transmitting time determination unit 632. Specifically, for example, the combining unit 64 generates the control signal including the scheduling request in response to the notification of the SR transmitting time (SR transmitting slot) by the SR transmitting time determination unit 632. The combining unit 64 generates the composite signal by combining the control signal including the scheduling request with the physical layer signal corresponding to the notified SR transmitting slot. The combining unit 64 then transmits the composite signal to the second layer 412.

The second layer 412 acquires DCI generated by a scheduler 40 in accordance with the scheduling request in the composite signal. This DCI indicates a communication resource allocated to the terminal device 5 for uplink data transmitting. The second layer 412 transmits a downlink signal including the DCI to the first layer 411.

The first layer 411 receives the downlink signal including the DCI from the second layer 412 and transmits a radio signal including the DCI to the terminal device 5 via an antenna. In addition, the first layer 411 receives, via the antenna, a radio signal including uplink data that is transmitted from the terminal device 5 by using the communication resource indicated in the DCI.

The terminal device 5 receives the radio signal including the DCI via an antenna. The terminal device 5 transmits uplink data that has occurred to the base station 4 by using the communication resource indicated in the DCI.

Therefore, the processing device 42 of the base station 4 can shorten latency from the occurrence to transmitting of the uplink data in the terminal device 5, compared to the terminal device 5C of the comparative example which transmits a scheduling request and receives DCI after uplink data actually occurs. Even in a case where uplink data does not occur in the terminal device 5 at a fixed cycle, the processing device 42 can transmit a scheduling request to the second layer 412 before uplink data actually occurs in the terminal device 5, based on the predicted UL data occurrence time.

Normally, radio signals transmitted from a plurality of terminal devices 5 propagate through space and are combined and received at the antenna of the base station 4. This combination corresponds to an arithmetic process of simple addition. Therefore, for example, the first layer 411 of the base station 4 adds, to any of a baseband signal converted from the received signal, the digitized baseband signal, the signal on which a beamforming process has been performed, and the signal on which an FFT process has been performed, a signal on which a similar process has been performed, thereby generating a composite signal similar to the signal combined at the antenna. The combining unit 64 of the processing device 42 uses this characteristic to combine (add) a control signal including a scheduling request with (to) an uplink signal (physical layer signal).

Because the combining unit 64 combines a control signal including a scheduling request with an uplink signal, the processing device 42 can transmit the composite signal including the scheduling request to the second layer 412 even in a case where the terminal device 5 has not transmitted a scheduling request. In other words, the processing device 42 can generate the scheduling request that is equivalent to a scheduling request transmitted by the terminal device 5 and transmit it to the second layer 412. The processing device 42 transmits a composite signal including the scheduling request to the second layer 412 (more specifically, to the scheduler 40) before uplink data actually occurs in the terminal device 5. Therefore, the processing device 42 can shorten the latency from the occurrence to transmitting of uplink data in the terminal device 5, compared to the terminal device 5C of the comparative example which transmits a scheduling request and receives DCI after uplink data actually occurs. Therefore, the processing device 42 can reduce the latency of uplink data transmitting by the terminal device 5.

FIG. 15 illustrates the example of the processing device 42 including the plurality of processing units (controller 63 and combining unit 64) that realize the multiple functions, respectively. However, the processing device 42 may include a single processing unit that realizes the functions. Each of the single processing unit and the plurality of processing units may be configured by hardware such as a field programmable gate array (FPGA). Alternatively, each of the single processing unit and the plurality of processing units may be configured by at least one processor. The processor can realize the functions of the processing device 42 by executing a program. The program executed by the processor is stored in a nonvolatile memory.

Next, an example of a connection point of the processing device 42 inside the base station 4, that is, the interface between the first layer 411 and the second layer 412, will be described.

FIG. 16 illustrates an example of a protocol stack of the base station 4. The 3GPP defines that the layers 41 of the base station 4 include a radio resource control (RRC) layer 81, a packet data convergence protocol (PDCP) layer 82, a radio link control (RLC) layer 83, a media access control (MAC) layer 84, a physical (PHY) layer 85, and a radio frequency (RF) layer 86.

The RRC layer 81 is connected to a core network 3 and controls radio resources in a wireless network. The PDCP layer 82 performs ciphering/deciphering, integrity protecting/checking, header compressing/decompressing, etc. The RLC layer 83 performs retransmitting control, duplication detecting, reordering, etc. The MAC layer 84 performs communication resource allocating (scheduling), retransmitting control, etc. The PHY layer 85 is a physical layer that performs modulation/demodulation, coding/decoding, etc. The RF layer 86 is a layer connected to the antenna. Each of the RLC layer 83, the MAC layer 84, and the PHY layer 85 may be further divided into a high layer and a low layer. Each layer is realized, for example, as at least one processing unit.

FIG. 17 illustrates an example of the protocol stack and interfaces of the base station 4. The RLC layer 83 is divided into a high RLC layer 83H and a low RLC layer 83L. The MAC layer 84 is divided into a high MAC layer 84H and a low MAC layer 84L. The PHY layer 85 is divided into a high PHY layer 85H and a low PHY layer 85L. The low PHY layer 85L is connected to the RF layer 86.

The interfaces between layers may be constructed with standard interfaces. The 3GPP specifies eight options for the interfaces between layers, from an Option 1 to an Option 8. For example, the interface between the RF layer 86 and the low PHY layer 85L is the Option 8. The interface between the low PHY layer 85L and the high PHY layer 85H is the Option 7. The interface between the high PHY layer 85H and the low MAC layer 84L is the Option 6.

Open RAN alliance (O-RAN) has proposed a configuration called O-RAN split option 7-2x in which the Option 7 specified by the 3GPP is subdivided into an Option 7-1 and an Option 7-2. The O-RAN is an industry organization that develops RAN specifications.

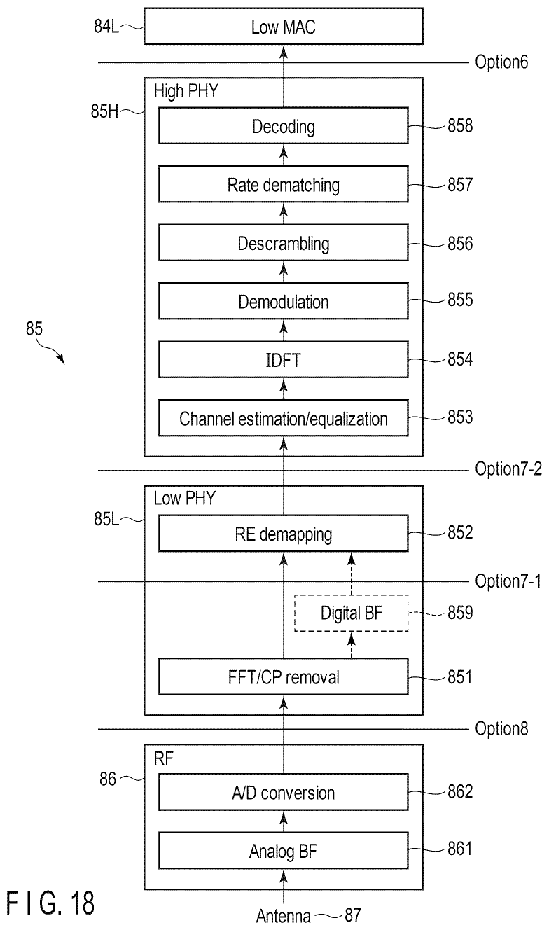

FIG. 18 illustrates an example of processing units corresponding to the RF layer 86, the low PHY layer 85L, and the high PHY layer 85H for uplink communication in the base station 4 in a case where the O-RAN split option 7-2x is used.

The processing unit of the RF layer 86 includes an analog beamforming (analog BF) unit 861 and an analog-to-digital conversion unit (A/D conversion unit) 862. The analog BF unit 861 controls the directivity of an RF signal (high-frequency signal) received by an antenna 87 (e.g., array antenna). The A/D conversion unit 862 converts the RF signal into a digital signal and transmits the digital signal to the processing unit of the low PHY layer 85L. The digital signal transmitted from the RF layer 86 to the low PHY layer 85L is a physical layer signal.

The processing unit of the low PHY layer 85L includes a Fourier transform (FFT)/continuous pilot (CP) removal unit 851 and a resource element demapping (RE demapping) unit 852. The FFT/CP removal unit 851 and the RE demapping unit 852 perform an FFT process on the digital signal (orthogonal frequency division multiplexing (OFDM) signal in a time domain) output from the RF layer 86, remove a continuous pilot signal from the OFDM signal, perform an RE demapping process, and generate I/Q samples of the OFDM signal in a frequency domain.

The processing unit of the high PHY layer 85H includes a channel estimation/equalization unit 853, an inverse discrete Fourier transform (IDFT) unit 854, a demodulation unit 855, a descrambling unit 856, a rate dematching unit 857, and a decoding unit 858. The channel estimation/equalization unit 853, the IDFT unit 854, the demodulation unit 855, the descrambling unit 856, the rate dematching unit 857, and the decoding unit 858 perform a channel estimation/equalization process, an IDFT process, a demodulation process, a descrambling process, and a decoding process on the I/Q samples of the OFDM signal in the frequency domain to obtain a bit string, and transmit the bit string to the MAC layer 84 (the low MAC layer 84L in FIG. 18). This bit string is referred to as a MAC layer signal. In other words, the low PHY layer 85L and the high PHY layer 85H convert the physical layer signal into the MAC layer signal by performing the various processes on the physical layer signal.

Note that, in the above example, the beamforming process is performed on the analog signal; however, the beamforming process may also be performed on the digital signal. In that case, instead of the analog BF unit 861, a digital beamforming (digital BF) unit 859 is provided between the FFT/CP removal unit 851 and the RE demapping unit 852.

The processing device 42 is arranged inside the PHY layer 85 (low PHY layer 85L and high PHY layer 85H). The processing device 42 may be arranged at an interface of the Option 7-1. The Option 7, which is defined in the 3GPP as the interface between the low PHY layer 85L and the high PHY layer 85H, is referred to as the Option 7-1 in the O-RAN. In this case, the first layer 411 is the FFT/CP removal unit 851 of the low PHY layer 85L. The second layer 412 is the RE demapping unit 852 of the low PHY layer 85L. In a case where the beamforming process is performed on the digital signal, the first layer 411 is the digital BF unit 859 of the low PHY layer 85L. The second layer 412 is the RE demapping unit 852 of the low PHY layer 85L.

The processing device 42 may be arranged at an interface of the Option 7-2. In this case, the first layer 411 is the low PHY layer 85L. The second layer 412 is the high PHY layer 85H.

Furthermore, the processing device 42 may be arranged at an interface between adjacent processing units within the high PHY layer 85H, which is currently not standardized. In other words, the processing device 42 may be arranged at any one of an interface between the channel estimation/equalization unit 853 and the IDFT unit 854, an interface between the IDFT unit 854 and the demodulation unit 855, an interface between the demodulation unit 855 and the descrambling unit 856, an interface between the descrambling unit 856 and the rate dematching unit 857, and an interface between the rate dematching unit 857 and the decoding unit 858.

Since the processing device 42 is arranged inside the PHY layer 85, the uplink signal transmitted from the first layer 411 to the processing device 42 is a physical layer signal. The uplink signal transmitted from the processing device 42 to the second layer 412 is also a physical layer signal. The MAC layer 84 includes the scheduler 40. The base station 4 is divided into two functional parts so that the scheduler 40 is included in the second layer 412.

With the above arrangement of the processing device 42, the processing device 42 can transmit, to the second layer 412, a composite signal (physical layer signal) including a scheduling request that is equivalent to a scheduling request transmitted by the terminal device 5 to the base station 4.

Next, a flow of an operation between the base station 4 and the terminal device 5 will be described.

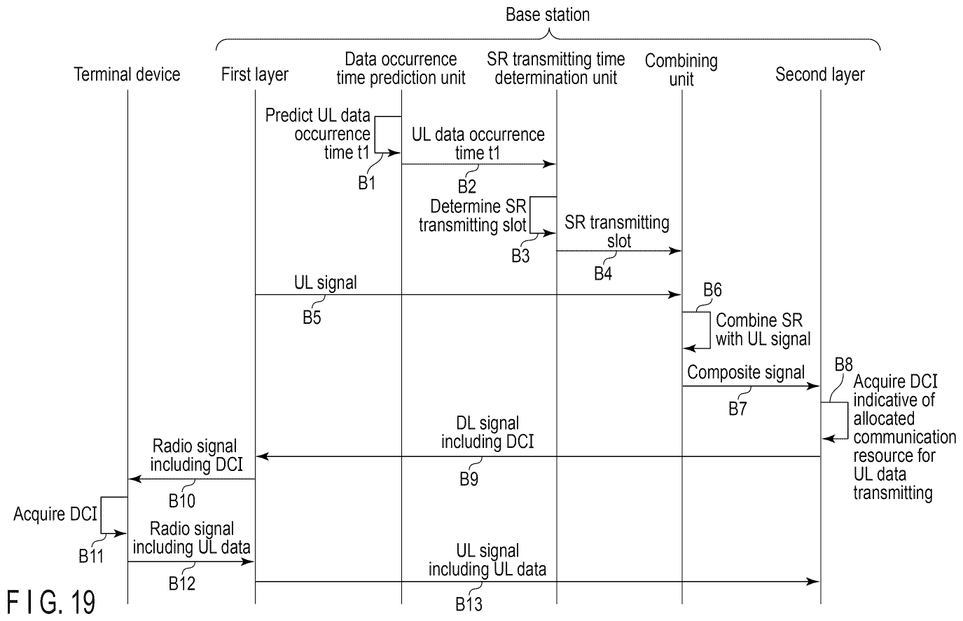

FIG. 19 is a sequence diagram illustrating an example of an operation for transmitting uplink data from the terminal device 5 to the base station 4. Here, it is assumed that a case where uplink data actually occurs between a time when the base station 4 combines a control signal including a scheduling request with an uplink signal and a time when the terminal device 5 receives DCI from the base station 4.

First, the data occurrence time prediction unit 631 of the base station 4 predicts the next UL data occurrence time t1 in the terminal device 5 (B1). The data occurrence time prediction unit 631 sends the predicted UL data occurrence time t1 to the SR transmitting time determination unit 632 (B2).

The SR transmitting time determination unit 632 determines an SR transmitting slot with which a scheduling request is to be transmitted on the basis of the received UL data occurrence time t1 and the allocation information 612 (B3). The SR transmitting time determination unit 632 notifies the combining unit 64 of the determined SR transmitting slot (B4).

The combining unit 64 receives, from the first layer 411, an uplink signal corresponding to the SR transmitting slot notified by the SR transmitting time determination unit 632 (B5). The combining unit 64 generates a control signal including a scheduling request and generates a composite signal by combining the generated control signal with the uplink signal (B6). The combining unit 64 transmits the generated composite signal to the second layer 412 (B7).

The second layer 412 acquires DCI generated in accordance with the scheduling request included in the composite signal (B8). The DCI indicates, for example, a communication resource for uplink data transmitting that has been allocated to the terminal device 5 by the scheduler 40 in the MAC layer 84 in accordance with the scheduling request. The second layer 412 transmits a downlink signal including the acquired DCI to the first layer (B9).

Based on the downlink signal including the DCI received from the second layer 412, the first layer 411 transmits a radio signal including the DCI to the terminal device 5 (B10). Specifically, the first layer 411 radiates the radio signal including the DCI via the antenna.

The terminal device 5 (more specifically, the communication device 53) receives the radio signal including the DCI from the base station 4 via the antenna and acquires the DCI from the received radio signal (B11). The terminal device 5 transmits a radio signal including uplink data to the base station 4 by using the communication resource indicated in the acquired DCI (B12). Specifically, the terminal device 5 radiates the radio signal including the uplink data via the antenna.

The first layer 411 receives the radio signal including the uplink data from the terminal device 5 via the antenna, and based on the received radio signal, transmits an uplink signal including the uplink data to the second layer 412 (B13).

By the above operation, the processing device 42 of the base station 4 combines the control signal including the scheduling request with the uplink signal before the uplink data actually occurs in the terminal device 5, based on the predicted UL data occurrence time t1. The terminal device 5 receives, from the base station 4, the DCI indicative of the communication resource allocated in accordance with this scheduling request. This enables the terminal device 5 to shorten the latency from the occurrence to transmitting of the uplink data, compared to the terminal device 5C of the comparative example that transmits a scheduling request and receives DCI after uplink data actually occurs. Therefore, the processing device 42 can reduce the latency of the transmitting of uplink data by the terminal device 5.

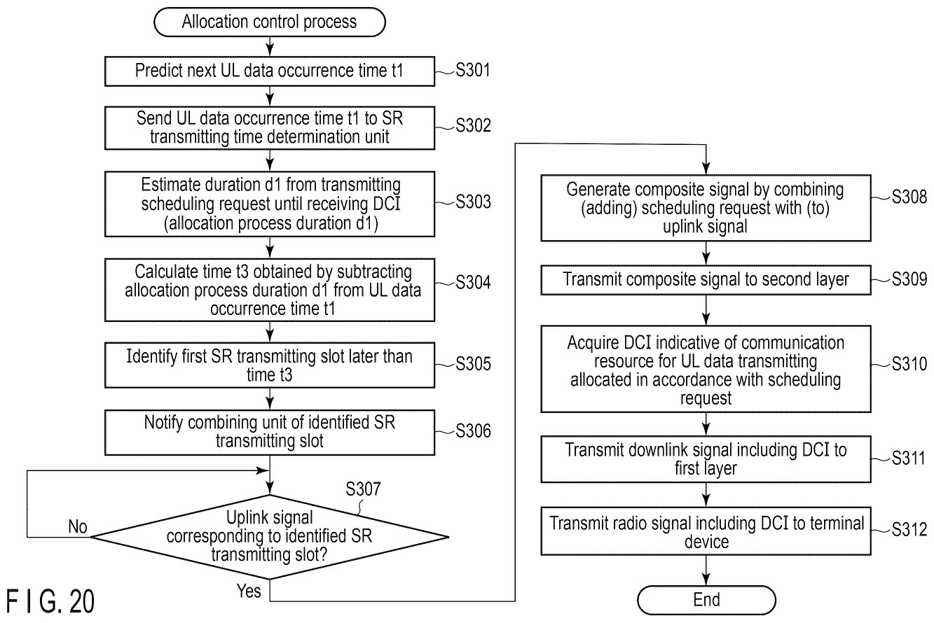

FIG. 20 is a flowchart illustrating an example of the procedure of an allocation control process executed in the base station 4. The allocation control process is a process for predicting the next UL data occurrence time in the terminal device 5 and controlling allocation of a communication resource for uplink data transmitting. For example, in response to an occurrence of uplink data in the terminal device 5 or in response to receiving of uplink data from the terminal device 5, the base station 4 executes the allocation control process for the next uplink data transmitting by the terminal device 5.

In the base station 4, first, the data occurrence time prediction unit 631 of the processing device 42 predicts the next UL data occurrence time t1 (step S301). Specifically, for example, the data occurrence time prediction unit 631 performs machine learning to which the communication/state data of the terminal device 5 is input and then generates the next UL data occurrence time t1. The data occurrence time prediction unit 631 sends the predicted UL data occurrence time t1 to the SR transmitting time determination unit 632 (step S302).

The SR transmitting time determination unit 632 estimates a duration d1 from when a scheduling request is transmitted to the second layer 412 until when the terminal device 5 receives DCI indicative of a communication resource allocated for uplink data transmitting (allocation process duration d1) (step S303). The SR transmitting time determination unit 632 calculates a time t3 by subtracting the allocation process duration d1 from the UL data occurrence time t1 (step S304). The SR transmitting time determination unit 632 identifies the first SR transmitting slot that is later than the time t3 from the contiguous slots 71 in the time domain (step S305). The SR transmitting time determination unit 632 then notifies the combining unit 64 of the identified SR transmitting slot (step S306).

Next, the combining unit 64 determines whether or not an uplink signal being transmitted from the first layer 411 is an uplink signal corresponding to the identified SR transmitting slot (step S307).

When the uplink signal being transmitted from the first layer 411 is not the uplink signal corresponding to the identified SR transmitting slot (No in step S307), the process by the combining unit 64 returns to step S307. In other words, the combining unit 64 waits to transmit a scheduling request (more precisely, waits to combine a control signal including a scheduling request) until the uplink signal corresponding to the identified SR transmitting slot is received from the first layer 411.

When the uplink signal being transmitted from the first layer 411 is the uplink signal corresponding to the identified SR transmitting slot (Yes in step S307), the combining unit 64 generates a control signal including a scheduling request and combines the generated control signal with the uplink signal, thereby generating a composite signal (step S308). The combining unit 64 transmits the generated composite signal to the second layer 412 (step S309).

The second layer 412 acquires, from the scheduler 40, DCI indicative of a communication resource for uplink data transmitting allocated in accordance with the scheduling request in the composite signal (step S310). The second layer 412 transmits a downlink signal including the acquired DCI to the first layer 411 (step S311).

Based on the downlink signal received from the second layer 412, the first layer 411 transmits a radio signal including the DCI to the terminal device 5 (step S312), and ends the allocation control process.

With the allocation control process described above, the processing device 42 can transmit the composite signal including the scheduling request to the second layer 412 before uplink data actually occurs in the terminal device 5, based on the predicted UL data occurrence time t1. The processing device 42 predicts the UL data occurrence time t1, for example, by machine learning using the communication/state data of the terminal device 5 as input. This enables the processing device 42 to transmit the composite signal including the scheduling request to the second layer 412 before uplink data actually occurs, based on the regularity of the occurrence of uplink data, for example, even in a case where uplink data does not occur at a fixed cycle in the terminal device 5.

As described above, according to the first and second embodiments, latency of transmitting uplink data can be reduced.

The controller 52 of the terminal device 5 predicts a UL data occurrence time at which uplink data to be transmitted to the base station 4 will occur. Based on the UL data occurrence time, the communication device 53 transmits a scheduling request, which requests allocation of a communication resource, to the base station 4 at the SR transmitting time before uplink data actually occurs.

As a result, for example, based on DCI for the scheduling request that has been transmitted before uplink data actually occurs, the communication device 53 of the terminal device 5 can transmit the uplink data by using a communication resource indicated in the DCI. Therefore, the terminal device 5 can reduce latency of transmitting the uplink data.

Alternatively, in the processing device 42 of the base station 4, the controller 63 predicts a UL data occurrence time at which uplink data to be transmitted to the base station 4 will occur in the terminal device 5. The combining unit 64 generates a composite signal by combining a control signal with a physical layer signal at an SR transmitting time before uplink data actually occurs, based on the UL data occurrence time. The control signal includes a scheduling request requesting allocation of a communication resource. The physical layer signal is transmitted from the first layer 411 to the second layer 412. The combining unit 64 transmits the composite signal to the second layer 412.

As a result, DCI that indicates a communication resource allocated in accordance with the scheduling request in the composite signal is transmitted to the terminal device 5. For example, based on the DCI for the scheduling request that has been transmitted by the processing device 42 before uplink data actually occurs, the communication device 53 of the terminal device 5 can transmit the uplink data by using the communication resource indicated in the DCI. Therefore, the processing device 42 can reduce latency of transmitting the uplink data by the terminal device 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

An appendix related to the embodiments is further described below.

<1> A terminal device wirelessly communicating with a base station, the terminal device comprising:
a controller configured to predict a first time at which first data to be transmitted to the base station will occur; and
a communication device configured to transmit a scheduling request to the base station at a second time before the first data actually occurs, based on the first time, the scheduling request requesting allocation of a communication resource.

<2> The terminal device of <1>, wherein
the communication device is capable of transferring data between the terminal device and the base station by using at least one of slots that are contiguous in a time domain,
the slots include at least one slot of a first type that is allocated for transmitting the scheduling request,
the controller is configured to:
   estimate a first duration from transmitting the scheduling request by using a slot of the first type until receiving control information, the control information being indicative of the communication resource that is allocated by the base station in accordance with the scheduling request;
   identify a first slot of the first type that is later than a third time that is obtained by subtracting the first duration from the first time; and
the communication device configured to transmit the scheduling request to the base station by using the identified slot of the first type.

<3> The terminal device of <1> or <2>, wherein
the controller is configured to predict the first time by using at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<4> The terminal device of <1> or <2>, wherein
the controller is configured to predict the first time by machine learning using time-series data of at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<5> The terminal device of <2>, wherein
the controller is configured to determine the second time by using the first time and using at least one of a cycle at which a slot of the first type is allocated, a current time, a duration from transmitting a scheduling request until receiving control information in a past in the terminal device, an amount of a communication resource allocated to the terminal device by the base station in a past, slice information, an amount and a receiving time of downlink data received from the base station in the past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<6> The terminal device of any one of <1> to <5>, wherein
the communication device is configured to:
   receive control information indicative of a first communication resource allocated by the base station in accordance with the transmitted scheduling request; and
   transmit the first data to the base station by using the first communication resource.

<7> A processing device arranged in an interface between a first layer and a second layer that are included in a base station which wirelessly communicates with a terminal device, the processing device comprising:
a controller configured to predict a first time at which first data to be transmitted to the base station will occur in the terminal device; and
a combining unit configured to:
   generate, based on the first time, a composite signal at a second time before the first data actually occurs by combining a control signal with a physical layer signal, the control signal including a scheduling request that requests allocation of a communication resource, the physical layer signal being transmitted from the first layer to the second layer; and
   transmit the composite signal to the second layer.

<8> The processing device of <7>, wherein
the physical layer signal corresponds to at least one of slots that are contiguous in a time domain,
the slots include at least one slot of a first type that is allocated for transmitting the scheduling request,
the controller is configured to:
   estimate a first duration from transmitting the scheduling request by using a slot of the first type until receiving a signal by the terminal device, the signal including control information indicative of the communication resource that is allocated in accordance with the scheduling request; and
   identify a slot of the first type that is later than a third time that is obtained by subtracting the first duration from the first time, and
the combining unit is configured to generate the composite signal by combining the control signal with the physical layer signal that corresponds to the identified slot of the first type.

<9> The processing device of <7> or <8>, wherein
the controller is configured to predict the first time by using at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<10> The processing device of <7> or <8>, wherein
the controller is configured to predict the first time by machine learning using time-series data of at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<11> The processing device of <8>, wherein
the controller is configured to determine the second time by using the first time and using at least one of a cycle at which a slot of the first type is allocated, a current time, a duration from transmitting a scheduling request until receiving control information in a past, an amount of a communication resource allocated by the base station in the past, slice information, an amount and a receiving time of downlink data received from the base station in the past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

<12> The processing device of one of <7> to <11>, wherein
the second layer is configured to transmit a signal that includes first control information to the first layer, the first control information being indicative of a first communication resource allocated in accordance with the scheduling request in the composite signal, and
the first layer is configured to transmit a signal that includes the first control information to the terminal device.

<13> The processing device of <12>, wherein
the first layer is configured to receive, from the terminal device, a signal that includes the first data transmitted by using the first communication resource.

<14> A non-transitory computer-readable storage medium having stored thereon a computer program which is executable by a computer, the computer program comprising instructions capable of causing the computer to execute functions of:
predicting a first time at which first data to be transmitted to the base station will occur; and
transmitting a scheduling request to the base station at a second time before the first data actually occurs, based on the first time, the scheduling request requesting allocation of a communication resource.

What is claimed is:

1. A terminal device wirelessly communicating with a base station, the terminal device comprising:
a controller configured to predict a first time at which first data to be transmitted to the base station will occur; and
a communication device configured to transmit a scheduling request to the base station at a second time before the first data actually occurs, based on the first time, the scheduling request requesting allocation of a communication resource.

2. The terminal device of claim 1, wherein
the communication device is capable of transferring data between the terminal device and the base station by using at least one of slots that are contiguous in a time domain,
the slots include at least one slot of a first type that is allocated for transmitting the scheduling request,
the controller is configured to:
estimate a first duration from transmitting the scheduling request by using a slot of the first type until receiving control information, the control information being indicative of the communication resource that is allocated by the base station in accordance with the scheduling request;
identify a first slot of the first type that is later than a third time that is obtained by subtracting the first duration from the first time; and
the communication device configured to transmit the scheduling request to the base station by using the identified slot of the first type.

3. The terminal device of claim 1, wherein
the controller is configured to predict the first time by using at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

4. The terminal device of claim 1, wherein
the controller is configured to predict the first time by machine learning using time-series data of at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

5. The terminal device of claim 2, wherein
the controller is configured to determine the second time by using the first time and using at least one of a cycle at which a slot of the first type is allocated, a current time, a duration from transmitting a scheduling request until receiving control information in a past in the terminal device, an amount of a communication resource allocated to the terminal device by the base station in a past, slice information, an amount and a receiving time of downlink data received from the base station in the past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

6. The terminal device of claim 1, wherein
the communication device is configured to:
receive control information indicative of a first communication resource allocated by the base station in accordance with the transmitted scheduling request; and
transmit the first data to the base station by using the first communication resource.

7. A processing device arranged in an interface between a first layer and a second layer that are included in a base station which wirelessly communicates with a terminal device, the processing device comprising:
a controller configured to predict a first time at which first data to be transmitted to the base station will occur in the terminal device; and
a combining unit configured to:
generate, based on the first time, a composite signal at a second time before the first data actually occurs by combining a control signal with a physical layer signal, the control signal including a scheduling request that requests allocation of a communication resource, the physical layer signal being transmitted from the first layer to the second layer; and
transmit the composite signal to the second layer.

8. The processing device of claim 7, wherein
the physical layer signal corresponds to at least one of slots that are contiguous in a time domain,
the slots include at least one slot of a first type that is allocated for transmitting the scheduling request,
the controller is configured to:
estimate a first duration from transmitting the scheduling request by using a slot of the first type until receiving a signal by the terminal device, the signal including control information indicative of the communication resource that is allocated in accordance with the scheduling request; and
identify a slot of the first type that is later than a third time that is obtained by subtracting the first duration from the first time, and
the combining unit is configured to generate the composite signal by combining the control signal with the physical layer signal that corresponds to the identified slot of the first type.

9. The processing device of claim 7, wherein
the controller is configured to predict the first time by using at least one of slice information, an amount and a receiving time of downlink data received from the base station in a past, an amount and a transmitting time of uplink data transmitted to the base station in the past, a channel quality indicator (CQI), quality of experience (QoE), quality of service (Qos), reference signal received power (RSRP), reference signal received quality (RSRQ), an error rate, a received signal strength indicator (RSSI), a route map, a radio wave map, and a used frequency that correspond to the terminal device.

10. The processing device of claim 7, wherein
the controller is configured to predict the first time by machine learning using time-series data of at least one of slice information, an amount and a receiving time of downlink data received from the base station in a past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

11. The processing device of claim 8, wherein
the controller is configured to determine the second time by using the first time and using at least one of a cycle at which a slot of the first type is allocated, a current time, a duration from transmitting a scheduling request until receiving control information in a past, an amount of a communication resource allocated by the base station in the past, slice information, an amount and a receiving time of downlink data received from the base station in the past, an amount and a transmitting time of uplink data transmitted to the base station in the past, a channel quality indicator (CQI), quality of experience (QoE), quality of service (QOS), reference signal received power (RSRP), reference signal received quality (RSRQ), an error rate, a received signal strength indicator (RSSI), a route map, a radio wave map, and a used frequency that correspond to the terminal device.

12. The processing device of claim 7, wherein
the second layer is configured to transmit a signal that includes first control information to the first layer, the first control information being indicative of a first communication resource allocated in accordance with the scheduling request in the composite signal, and
the first layer is configured to transmit a signal that includes the first control information to the terminal device.

13. The processing device of claim 12, wherein
the first layer is configured to receive, from the terminal device, a signal that includes the first data transmitted by using the first communication resource.

14. A non-transitory computer-readable storage medium having stored thereon a computer program which is executable by a computer, the computer program comprising instructions capable of causing the computer to execute functions of:
predicting a first time at which first data to be transmitted to the base station will occur; and
transmitting a scheduling request to the base station at a second time before the first data actually occurs, based on the first time, the scheduling request requesting allocation of a communication resource.
